(19) United States
(12) Patent Application Publication
(10) Pub. No.: US 2024/0178399 A1
(43) Pub. Date: May 30, 2024

(54) COMPOSITE FLUOROPOLYMER BINDER AND METHODS OF MAKING SAME, COMPOSITE BINDER MATERIAL AND METHOD FOR PRODUCING SAME, ELECTRODE, ENERGY STORAGE DEVICE, BINDER POWDER FOR ELECTROCHEMICAL DEVICE AND METHOD FOR PRODUCING SAME, BINDER FOR ELECTROCHEMICAL DEVICE, ELECTRODE MIXTURE, ELECTRODE FOR SECONDARY BATTERY, AND SECONDARY BATTERY

(71) Applicants: DAIKIN AMERICA, INC., Orangeburg, NY (US); DAIKIN INDUSTRIES, LTD., Osaka-shi (JP)

(72) Inventors: Alec FALZONE, Magnolia, TX (US); Emily Grumbles, Tallahassee, FL (US); Wade Simpson, Decatur, AL (US); Joseph Sunstrom, Trinity, AL (US); Ronald Hendershot, Decatur, AL (US); Taku Yamanaka, Osaka-shi (JP); Taketo Kato, Osaka-shi (JP); Takaya Yamada, Osaka-shi (JP); Junpei Terada, Osaka-shi (JP); Masato Tokuda, Osaka-shi (JP); Kenta Nishimura, Osaka-shi (JP)

(73) Assignees: DAIKIN AMERICA, INC., Orangeburg, NY (US); DAIKIN INDUSTRIES, LTD., Osaka-shi (JP)

(21) Appl. No.: 18/412,161

(22) Filed: Jan. 12, 2024

Related U.S. Application Data
(63) Continuation of application No. PCT/JP2022/027467, filed on Jul. 12, 2022.
(60) Provisional application No. 63/220,687, filed on Jul. 12, 2021.

(51) Int. Cl. H01M 4/62; C08J 3/20; C08L 27/18; H01M 4/02

(52) U.S. Cl. CPC H01M 4/623; C08J 3/203; C08L 27/18; C08J 2327/18; C08J 2427/16; C08L 2203/20; H01M 2004/021; H01M 4/625

(57) ABSTRACT

Composite binder materials for energy storage applications are disclosed. The composite binder materials include a fluoropolymer, such as polytetrafluoroethylene (PTFE), integrated with a conductive additive and a low-melting point thermoplastic. Methods of making the composite binder materials are also disclosed. The methods include providing an emulsion of the fluoropolymer, mixing the low-melting point thermoplastic and the particulate conductive additive into the emulsion of the fluoropolymer to form a mixture, and coagulating the mixture to produce a coagulum including the composite binder material. The disclosure also provides a binder powder for an electrochemical device capable of providing an electrode mixture sheet having excellent uniformity of tensile strength. The disclosure relates to a binder powder for an electrochemical device, containing a non-fibrillated fibrillatable resin and a thermoplastic polymer.

### CROSS-REFERENCE TO RELATED APPLICATIONS

This application is a Rule 53(b) Continuation of International Application No. PCT/JP2022/027467 filed on Jul. 12, 2022, claiming priority based on U.S. Application No. 63/220,687 filed on Jul. 12, 2021, the respective disclosures of which are incorporated herein by reference in their entirety.

### TECHNICAL FIELD

The present disclosure relates generally to composite fluoropolymer binder materials for energy storage devices and methods of making same.

The disclosure relates to composite binder materials and methods for producing same, electrodes, energy storage devices, binder powders for electrochemical devices and methods for producing same, binders for electrochemical devices, electrode mixtures, electrodes for secondary batteries, and secondary batteries.

### BACKGROUND ART

Generally, binder materials are combined with active electrode materials and other additives and processed in a way that forms an electrode film. The current solution for forming cathodes involves mixing polyvinylidene difluoride (PVdF) with a solvent, such as N-methyl pyrrolidone (NMP), then mixing the solution with a conductive additive, such as carbon black and/or carbon nanotubes, and electrode materials to create a slurry. Anodes are generally prepared using an aqueous method, with styrene butadiene rubber/carboxymethyl cellulose (SBR-CMC) as the most commonly used binder. The resulting suspension is cast onto either an aluminum cathode or copper anode current collector, or other metal alloy for use in a battery. While the current process is well known, it suffers from several drawbacks, including the use of PVdF, which has a high dielectric constant (greater than 3.0), and the safety, environmental, and cost considerations of NMP.

Polytetrafluoroethylene (PTFE) is a known substitute for PVdF; however, the insolubility of PTFE in NMP precludes its use in current practice. Another problem with PTFE and PVdF is that both fluoropolymers are insulators. A conductive additive must be added to the PTFE or PVdF if there is to be current flow in a cathode. Dry blending PTFE with a conductive additive, such as carbon black, does not provide good distribution through the PTFE matrix, which results in poor conduction. In addition, due to its high melting point, PTFE retains its shape even when melted, which means PTFE will not flow through or over any surface and cannot form a mechanical bond. Moreover, the temperatures needed to melt PTFE even if it could be made to flow exceeds the upper temperature capabilities of many heating devices commonly used in the manufacturing process.

Accordingly, there remains a need in the art for binder materials for energy storage applications that overcome the technical challenges of obtaining a homogenous mixture of PTFE and conductive additives.

Patent Literature 1 discloses a dry electrode film of an energy storage device, containing: a dry active material; and a dry binder containing a fibrillizable binder and a microparticulate non-fibrillizable binder having a D₅₀ particle size of about 0.5 to 40 μm, wherein the dry electrode film is free-standing.

Patent Literature 2 discloses an electrode film, containing a composite binder material containing polytetrafluoroethylene (PTFE) and poly(ethylene oxide) (PEO), wherein the electrode film is a free standing dry electrode film, and wherein the electrode film is absent of solvent residue.

Patent Literature 3 discloses a non-aqueous electrolyte solution cell containing a positive electrode active material mixture at least containing a positive electrode active material, a conductive agent, and a binder, wherein the binder is a binder mixture of a first binder that is fiberized to bind the positive electrode active material mixture and a second binder that is melted to bind the positive electrode active material mixture.

Patent Literature 4 discloses a process for producing an electrode for an electrochemical cell, in particular for a battery cell, for example for a lithium cell, the method including: mixing at least one binder and at least one particulate fibrillation aid by a high-shear mixing procedure, wherein the at least one binder is fibrillated; and admixing at least one electrode component with the at least one fibrillated binder by a low-shear mixing procedure.

Patent Literature 5 discloses an energy storage device including: a cathode; an anode; and a separator between the anode and the cathode, wherein at least one of the cathode or the anode contains a polytetrafluoroethylene (PTFE) composite binder material containing PTFE and at least one of polyvinylidene fluoride (PVDF), a PVDF co-polymer, and poly(ethylene oxide) (PEO).

### CITATION LIST

### Patent Literature

Patent Literature 1: JP 2021-519495 A
Patent Literature 2: JP 2019-216101 A
Patent Literature 3: JP 2000-149954 A
Patent Literature 4: U.S. Ser. No. 11/183,675 B
Patent Literature 5: JP 2017-517862 A

### SUMMARY

The problems expounded above, as well as others, are addressed by the following inventions, although it is to be understood that not every embodiment of the inventions described herein will address each of the problems described above. The present disclosure provides composite binder materials composed of a fluoropolymer, such as PTFE, integrated with a conductive additive and a low-melting point thermoplastic, such as a low-melting point fluoropolymer. The binder composite binder materials may be used, for example, as a binder for energy storage applications, such as in a cathode or anode. The addition of a melt-processable fluoropolymer also aids in the adhesion of the material to a current collector for use in batteries.

In a first aspect, a composite binder material is provided, the composite binder material including polytetrafluoroethylene (PTFE); a low-melting point thermoplastic; and a conductive additive.

### Advantageous Effects

The disclosure can provide a binder powder for an electrochemical device capable of providing an electrode mixture sheet having excellent uniformity of tensile strength.

### BRIEF DESCRIPTION OF DRAWINGS

Further features and advantages can be ascertained from the following detailed description that is provided in connection with the drawings described below:

FIGS. 1A and 1B are bulk images of PTFE particles integrated with conductive carbon and 5% w/w of a terpolymer of ethylene, tetrafluoroethylene, and hexafluoropropylene (EFEP) according to one embodiment of the present disclosure. FIGS. 1C, 1D, and 1E are high-resolution images of the PTFE particles shown in FIGS. 1A and 1B.

FIGS. 2A and 2B are bulk images of PTFE particles integrated with conductive carbon and 7.5% w/w of EFEP according to another embodiment of the present disclosure. FIGS. 2C, 2D, and 2E are high-resolution images of the PTFE particles shown in FIGS. 2A and 2B.

FIGS. 3A and 3B are bulk images of PTFE particles integrated with conductive carbon and 10% w/w of EFEP according to still another embodiment of the present disclosure. FIGS. 3C, 3D, and 3E are high-resolution images of the PTFE particles shown in FIGS. 3A and 3B.

FIGS. 4A and 4B are bulk images of PTFE particles integrated with conductive carbon and 20% w/w of EFEP according to still further embodiment of the present disclosure. FIGS. 4C, 4D, and 4E are high-resolution images of the PTFE particles shown in FIGS. 4A and 4B.

FIG. 5 is a graph showing the adhesion of PTFE particles integrated with conductive carbon and varying amounts of EFEP according to an embodiment of the present disclosure.

FIG. 6 is a graph showing the adhesion of high-molecular weight PTFE particles integrated with conductive carbon and varying amounts of EFEP according to an embodiment of the present disclosure.

FIG. 7 is a graph showing the adhesion of modified PTFE particles integrated with conductive carbon and varying amounts of EFEP according to an embodiment of the present disclosure.

FIG. 8 is a graph showing the adhesion of PTFE particles with no additives compared with PTFE particles integrated with conductive carbon and varying amounts of EFEP according to an embodiment of the present disclosure.

FIGS. 9A and 9B are ATR-FTIR spectra showing the functional groups of PTFE particles integrated with conductive carbon and EFEP according to an embodiment of the present disclosure.

FIG. 10A is a thermogravimetric analysis (TGA) scan of PTFE particles integrated with conductive carbon and 5% w/w EFEP according to an embodiment of the present disclosure. FIG. 10B is a TGA scan of PTFE particles integrated with conductive carbon and 7.5% w/w EFEP according to another embodiment of the present disclosure.

FIG. 10C is a TGA scan of PTFE particles integrated with conductive carbon and 10% w/w EFEP according to still another embodiment of the present disclosure. FIG. 10D is a TGA scan of PTFE particles integrated with conductive carbon and 20% w/w EFEP according to still further embodiment of the present disclosure.

FIG. 11 is a micrograph (magnification: 150×) of powder obtained in Production Example 1.

### DESCRIPTION OF EMBODIMENTS

Unless otherwise defined, all terms (including technical and scientific terms) used herein have the same meaning as commonly understood by one of ordinary skill in the art of this disclosure. It will be further understood that terms, such as those defined in commonly used dictionaries, should be interpreted as having a meaning that is consistent with their meaning in the context of the specification and should not be interpreted in an idealized or overly formal sense unless expressly so defined herein. Well known functions or constructions may not be described in detail for brevity or clarity.

The terms “about” and “approximately” shall generally mean an acceptable degree of error or variation for the quantity measured given the nature or precision of the measurements. Typical, exemplary degrees of error or variation are within 20 percent (%), preferably within 10%, more preferably within 5%, and still more preferably within 1% of a given value or range of values. Numerical quantities given in this description are approximate unless stated otherwise, meaning that the term “about” or “approximately” can be inferred when not expressly stated.

The terminology used herein is for the purpose of describing particular embodiments only and is not intended to be limiting. As used herein, the singular forms “a”, “an” and “the” are intended to include the plural (i.e., “at least one”) forms as well, unless the context clearly indicates otherwise.

The terms “first”, “second”, and the like are used herein to describe various features or elements, but these features or elements should not be limited by these terms. These terms are only used to distinguish one feature or element from another feature or element. Thus, a first feature or element discussed below could be termed a second feature or element, and similarly, a second feature or element discussed below could be termed a first feature or element without departing from the teachings of the present disclosure.

Terms such as “at least one of A and B” should be understood to mean “only A, only B, or both A and B.” The same construction should be applied to longer lists (e.g., “at least one of A, B, and C”).

The term “consisting essentially of” means that, in addition to the recited elements, what is claimed may also contain other elements (steps, structures, ingredients, components, etc.) that do not adversely affect the operability of what is claimed for its intended purpose as stated in this disclosure. This term excludes such other elements that adversely affect the operability of what is claimed for its intended purpose as stated in this disclosure, even if such other elements might enhance the operability of what is claimed for some other purpose.

The term “may” as used herein refers to features that are optional (i.e., “may or may not,”), and should not be construed to limit what is described.

It is to be understood that any given elements of the disclosed embodiments of the invention may be embodied in a single structure, a single step, a single substance, or the like. Similarly, a given element of the disclosed embodiment may be embodied in multiple structures, steps, substances, or the like.

### Composite Binder Materials

The present disclosure provides composite binder materials for energy storage applications. Various embodiments of the composite binder materials described herein have one or more of the following advantages: they provide homogenous and well-distributed mixtures of a fluoropolymer, such as PTFE, integrated with a conductive additive and a low-melting point thermoplastic; they are conductive; and they have the capability of adhering to metals, such as current collectors on electrodes.

In one embodiment, the composite binder material includes a fluoropolymer, such as polytetrafluoroethylene (PTFE). In one embodiment, the PTFE may be a PTFE homopolymer or include perfluorinated copolymers. In another embodiment, the PTFE may be a modified PTFE. A “modified PTFE” refers to a homopolymer of tetrafluoroethylene containing not more than 1% by weight of other fluoromonomers (see ASTM D4895-15). The modified PTFE may include a tetrafluoroethylene (TFE) unit and a modifying monomer unit based on a modifying monomer copolymerizable with TFE. The modifying monomer may be any monomer copolymerizable with TFE. In some embodiments, the modifying monomer may be partially fluorinated or perfluorinated. Examples of partially or perfluorinated modifying monomers include perfluoroolefins, such as hexafluoropropylene (HFP); chlorofluoroolefins, such as chlorotrifluoroethylene (CTFE); hydrogen-containing fluoroolefins, such as trifluoroethylene and vinylidene fluoride (VDF); perfluoroalkyl vinyl ethers having an alkyl chain containing 1, 2, 3, 4, 5, 6, 7, or 8 carbon atoms; perfluoroalkylethylenes; ethylene; and nitrile group-containing fluorinated vinyl ethers. In other embodiments, the modifying monomer may not contain fluorine.

The molecular weight of the fluoropolymer, such as PTFE, may be expressed in terms of a standard specific gravity (SSG), which is conventionally used as a criterion of the molecular weight of PTFE (see ASTM D-4441-15, ASTM D-4894-19, or ASTM D-4895-18). The relationship of SSG to molecular weight number (M n) is shown in Equation 1 below: SSG=−0.0579(1n(Md)+2.6113 (1).

In some embodiments, the PTFE may be a high molecular weight PTFE having a standard specific gravity of at least 2.150. In still further embodiments, the PTFE may be a high molecular weight PTFE having a standard specific gravity of at least 2.160. In still further embodiments, the PTFE may be a high molecular weight PTFE having a standard specific gravity of at least 2.170. The PTFE may be a high molecular weight PTFE having a standard specific gravity of 2.20 or less.

The PTFE may be present in the composite binder material in an amount of about 25% w/w to about 99% w/w. In another embodiment, the PTFE may be present in the composite binder material in an amount of about 40% w/w to about 99% w/w. In still another embodiment, the PTFE may be present in the composite binder material in an amount of about 60% w/w to about 99% w/w.

The composite binder material of the present disclosure may also include a low-melting point thermoplastic. A “low-melting point thermoplastic” as used herein refers to a polymer having a melting point at or below 375° C., preferably at or below 200° C., so that the polymer is melt-processable at the processing temperatures disclosed herein. For example, the low-melting point thermoplastic should be capable of being processed in a screw type extruder such that the screw is able to force the polymer through a die when the processing temperature is above the melting point of the polymer. Without being bound by any particular theory, it is believed that the low-melting point thermoplastic aids in the adhesion of the binder material to substrates, such as current collectors for cathodes and anodes.

In one embodiment, the low-melting point thermoplastic is a low-melting point fluoropolymer. Suitable low-melting point fluoropolymers include, but are not limited to, polyvinylidene fluoride (PVdF), polyfluoroethylene-propylene (FEP), polyethylene fluoroethylene-propylene (EFEP), polyethylene tetrafluoroethylene (ETFE), polytetrafluoroethylene, hexafluoropropylene and vinylidene fluoride (THV), fluoroelastomers (such as for example FKM and FFKM), polyperfluoro-alkoxy alkane (PFA), polyvinyl fluoride (PVF), and alloys and blends of the foregoing. In a preferred embodiment, the low-melting point fluoropolymer is EFEP.

In other embodiments, the low-melting point thermoplastic may be a low-melting point non-fluorinated polymer. Examples of low-melting point non-fluorinated polymers include, but are not limited to, polyolefins (such as polyethylene (PE) and polypropylene (PP)), polyamide (PA, such as Nylon), polystyrene (PS), thermoplastic polyurethane (TPU), polyimide (PI), polyacrylate (PA), polycarbonate (PC), polylactic acid (PLA), polyether ether ketone (PEEK), polyethylene glycol (PEG/PEO), and alloys and blends of the foregoing.

The low-melting point thermoplastic may be used in particulate form. For example, in some embodiments, the low-melting point thermoplastic is used in the form of a powder. In one embodiment, the powdered form of the low-melting point thermoplastic has an average particle size, as measured by Scanning Electron Microscopy (SEM), of about 700 μm or less. In another embodiment, the low-melting point thermoplastic has an average particle size of about 500 μm or less. In still another embodiment, the low-melting point thermoplastic has an average particle size of about 300 μm or less. In still further embodiments, the low-melting point thermoplastic has an average particle size of about 100 μm or less. In another embodiment, the low-melting point thermoplastic has an average particle size of about 50 μm or less.

Some embodiments of the low-melting point thermoplastic are used in the form of an emulsion. In this embodiment, the low-melting point thermoplastic may have an average primary particle size of about 500 nm or less. In further embodiments, the low-melting point thermoplastic may have an average primary particle size of about 450 nm or less. In still further embodiments, the low-melting point thermoplastic may have an average primary particle size of about 400 nm or less. In still further embodiments, the low-melting point thermoplastic may have an average primary particle size of about 350 nm or less. In still further embodiments, the low-melting point thermoplastic may have an average primary particle size of about 300 nm or less. In still further embodiments, the low-melting point thermoplastic may have an average primary particle size of about 250 nm or less. For example, the low-melting point thermoplastic may have an average primary particle size of 240, 230, 220, 210, 200, 190, 180, 170, 160, 150, 140, 130, 120, 110, or 100 nm.

The low-melting point thermoplastic may be present in the composite binder material in an amount of about 0.01% w/w to about 50% w/w. In further embodiments, the low-melting point thermoplastic may be present in the composite binder material in an amount of about 1% w/w to about 35% w/w. In still further embodiments, the low-melting point thermoplastic may be present in the composite binder material in an amount of about 5% w/w to about 20% w/w. In still further embodiment, the low-melting point thermoplastic may be present in the composite binder material in an amount of about 5% w/w to about 10% w/w.

The composite binder material of the present disclosure may further include a conductive additive. The conductive additive provides the composite binder material with increased dielectric properties. In one embodiment, the conductive additive is a conductive carbon. For example, the conductive additive may be a carbon nanoparticle, carbon nanotube, carbon black, acetylene black, graphite, or a combination of two or more of the foregoing. The conductive additive may be present in the composite binder material in an amount of about 0.01% w/w to about 20% w/w. More specifically, the conductive additive may be present in the composite binder material in an amount of about 1% w/w to about 15% w/w. More specifically, the conductive additive may be present in the composite binder material in an amount of about 2% w/w to about 10% w/w.

The composite binder materials of the present disclosure exhibit excellent adhesion strength. In some embodiments, the composite binder materials of the present disclosure have an adhesion strength of greater than 1 N mm with high-purity aluminum, when adhesion peel tested using a 25 mm width film with high-purity aluminum on both sides. Further embodiments of the composite binder materials have an adhesion strength of greater than 1.5, 2, or 2.5 N mm by the same measure.

When reference is made to adhesion peel testing, it refers to the adhesion peel test methodology described in the EXAMPLES section of this disclosure.

### Methods of Making the Composite Binder Materials

The present disclosure provides methods of making the composite binder materials. In one embodiment, the method includes providing an emulsion of the fluoropolymer, for example, PTFE. The fluoropolymer emulsion is obtainable by various suitable methods. For instance, a PTFE emulsion may be prepared by the aqueous polymerization of tetrafluoroethylene in the presence of an emulsifier, paraffin wax, and an initiator. The wax may be separated from the emulsion by decanting the emulsion from the lighter wax phase. In some embodiments, the emulsion may be coagulated to separate the fluoropolymer, for example, the PTFE, from the water. This step results in the formation of secondary particles comprised of the fluoropolymer.

After formation of the fluoropolymer emulsion, for example, the PTFE emulsion, the method includes mixing the low-melting point thermoplastic and the particulate conductive additive into the emulsion of the fluoropolymer to form a mixture. In this embodiment, the low-melting point thermoplastic and the particulate conductive additive may be added to the emulsion in any of the amounts disclosed above. The low-melting point thermoplastic may be added in particulate form, such as powdered form or in the form of an emulsion. In embodiments where the low-melting point thermoplastic is used in the form of an emulsion, the average particle size may be about 500 nm or less. In further embodiments, the emulsion's maximum average particle size may be 450, 400, 350, or 300 nm. The target range of particle sizes may be obtained by various suitable means, including through screening or filtration. After the low-melting point thermoplastic and the particulate conductive additive are added to the emulsion, the mixture may be coagulated. In one embodiment, coagulation occurs when sufficient energy is applied to the mixture, such as by mechanical agitation, to allow for coagulated secondary particles comprised of the fluoropolymer, low-melting point thermoplastic, and the particulate conductive additive to precipitate out of the mixture. In further embodiments, coagulation may be accomplished ionically using a monovalent, divalent, or trivalent salt, such as aluminum salts, calcium nitrate, sodium chloride, quaternary salts, or any other coagulation salt known in the art.

The coagulation step may be performed at a temperature at or below about 90° C. In further embodiments, the coagulation step is performed at a temperature ranging from about 5° C. to about 30° C., or about 5° C. to about 15° C. Prior to coagulation, the specific gravity of the fluoropolymer emulsion may be adjusted to about 1.050 to about 1.100. The coagulation step may be performed with any mechanical agitator capable of applying the energy sufficient to promote mixing and separation of the secondary particles from the mixture. For example, the mechanical agitator may be an anchor, impeller, or any other design that is capable of generating a vortex of the fluoropolymer emulsion within the agitator. In further embodiments, the coagulation vessel may contain one or more baffles or other design features to achieve coagulation.

The coagulation step of the present method may occur in three phases: the initial phase, the slurry phase, and the coagulated phase. The initial phase involves the low viscosity mixing of the fluoropolymer, the low-melting point thermoplastic, and the particulate conductive additive. The slurry phase occurs when the increased viscosity of the mixture becomes sufficient to eliminate or decrease the size of any vortex within the agitator. The coagulated phase occurs when there are distinct coagulated secondary particles comprised of the fluoropolymer integrated with the particulate conductive additive and low-melting point thermoplastic. The coagulated material may be decanted from any liquid formed during the coagulated phase. The resulting coagulum forms the composite binder material. In some embodiments, the liquid formed during the coagulated phase may be removed and the resulting slurry may be used as the composite binder material, in some embodiments, without the coagulum.

In some embodiments, the method includes drying the coagulum to remove any liquid polymerization media that may be trapped between particles due to capillary forces. In one embodiment, the coagulum is dried at a temperature at or below about 375° C. In further embodiments, the coagulum is dried at a temperature at or below about 300° C. In still further embodiments, the coagulum is dried at a temperature at or below about 200° C. For example, the coagulum may be dried at a temperature of about 177° C. After drying, the coagulum may be stored at a temperature at or below about 20° C. to prevent excessive fibrillation of the fluoropolymer (for example, the PTFE).

In some embodiments, the composite binder material formed from the method of the present disclosure may be combined with additional particulate conductive material, such as carbon black. In such embodiments, the composite binder material and the additional particulate conductive material may be combined using any mixing or grinding method that is capable of applying shear to the components. For example, the mixing method may be performed with any mechanical agitator capable of rotating at a high rate of speed to promote mixing of the composite binder material and the additional particulate conductive material.

The composite binder material may be combined with an electrode active material. Such electrodes find use, for example on an electrode in a battery or supercapacitor. For example, the electrode active material may be a positive electrode active material, such as lithium nickel manganese cobalt oxide (NMC), lithium cobalt oxide (LCO), lithium nickel cobalt aluminum oxide (NCA), lithium iron phosphate (LFP), lithium nickel manganese spinel (LNMO), and lithium manganese oxide (LMO), or a negative electrode active material, such as graphite, silicon, silicon composites, pyrocarbons, cokes, mesocarbon microbeads, carbon fiber, activated carbon, and pitch-coated graphite. The composite binder material and the electrode active material may be mixed to form an electrode mixture that may be applied to an electrode.

### Applications of Use

The composite binder materials described herein may be used in energy storage applications. In one embodiment, the present disclosure provides an electrode, such as a cathode or anode, produced by applying an electrode mixture comprised of the disclosed composite binder material to a current collector. In this embodiment, the electrode mixture may be formed by homogeneously dispersing a battery active material, an additional conductive additive, and the composite binder material. The battery active material may be any of the positive electrode active materials or negative electrode active materials described above. The battery active material may be added to the electrode mixture in an amount of about 90% w/w to about 99% w/w. The composite binder material may be added to the electrode mixture in an amount of about 0.5% w/w to about 10% w/w. The additional conductive additive may be added in an amount of about 9.5% w/w or less.

In one embodiment, the battery active material, the additional conductive additive, and the composite binder material may be dispersed using a low-energy, solvent free mixing process. For example, the components of the electrode mixture may be uniformly dispersed using a gentle mechanical mixing method to controllably integrate the composite binder material and the additional conductive additive throughout the battery active material, prior to and/or during the controlled fibrillation of the fluoropolymer. The mixing method may use a planetary type of agitation and be performed at a rpm ranging from about 10 rpm to about 100 rpm. In some embodiments, the mixing is performed at a temperature ranging from about 5° C. to about 90° C.

The homogenous electrode mixture containing the composite binder material of the present disclosure may be applied to a positive or negative electrode current collector. Examples of the material constituting the current collector include aluminum and alloys thereof, stainless steel, nickel and alloys thereof, titanium and alloys thereof, carbons, conductive resins, and materials produced by treating the surface of aluminum or stainless steel with carbon or titanium. The electrode mixture may be applied to the current collector using any suitable coating method, for example, by using a roller or press system. The coating method may be performed under ambient conditions. In other embodiments, the coating method may be performed at an elevated temperature from about room temperature (e.g., 20° C.) to about 375° C. Through the use of the composite binder material of the present disclosure, the electrode mixture may have enhanced adhesion to the current collector, which forms an electrode when applied to the current collector.

The present disclosure provides an energy storage device including at least one electrode, such as a cathode and/or anode, having a current collector coated with the electrode mixture containing the composite binder material described herein. Some embodiments of the energy storage device include at least two electrodes (or exactly two electrodes) containing the composite binder. The energy storage device may be a battery, such as a lithium ion battery. In other embodiments, the energy storage device may be a supercapacitor, an electric double layer capacitor, or a lithium ion capacitor. In still other embodiments, the energy storage device may be a lithium secondary cell.

The disclosure is also specifically described hereinbelow.

The disclosure relates to a binder powder for an electrochemical device, containing a non-fibrillated fibrillatable resin and a thermoplastic polymer.

The binder powder for an electrochemical device of the disclosure has any of the above features and can therefore provide an electrode mixture sheet having excellent uniformity of tensile strength. The binder powder also enables production of an electrochemical device at low cost. When a conductive additive is added, the binder powder enables uniform mixing with the fibrillatable resin. This can improve the adhesion between current collector foil and an electrode mixture sheet in an electrochemical device.

The phrase “containing a non-fibrillated fibrillatable resin” means that the proportion of the number of fibrillatable resin particles having an aspect ratio of 30 or higher is 20% or lower relative to the total number of the fibrillatable resin particles. The proportion of the number of fibrillatable resin particles having an aspect ratio of 30 or higher relative to the total number of the fibrillatable resin particles is preferably 15% or lower, more preferably 10% or lower, still more preferably 5% or lower, further preferably 3% or lower, further more preferably 2% or lower, still further more preferably 1% or lower, particularly preferably 0.5% or lower.

The proportion of the number of fibrillatable resin particles having an aspect ratio of 30 or higher relative to the total number of the fibrillatable resin particles is determined by the following method.

A microscope is used to take an enlarged photograph of resin powder, whereby an image is obtained. The magnification may be, for example, 30× to 1000×.

The resulting image is saved in a computer and read by Image analysis software ImageJ.

The number of particles counted is set to 200 or more.

Of the resin particles counted, the number of resin particles having an aspect ratio of 30 or higher is counted and the percentage thereof is calculated.

The phrase “containing a non-fibrillated fibrillatable resin” preferably means that the proportion of the number of fibrillatable resin particles having an aspect ratio of 20 or higher is 20% or lower relative to the total number of the fibrillatable resin particles. The proportion of the number of fibrillatable resin particles having an aspect ratio of 20 or higher relative to the total number of the fibrillatable resin particles is preferably 15% or lower, more preferably 10% or lower, still more preferably 5% or lower, further preferably 3% or lower, further more preferably 2% or lower, still further more preferably 1% or lower, particularly preferably 0.5% or lower.

The proportion of the number of fibrillatable resin particles having an aspect ratio of 20 or higher relative to the total number of the fibrillatable resin particles is determined by the following method.

A microscope is used to take an enlarged photograph of resin powder, whereby an image is obtained. The magnification may be, for example, 30× to 1000×.

The resulting image is saved in a computer and read by Image analysis software ImageJ.

The number of particles counted is set to 200 or more.

Of the resin particles counted, the number of resin particles having an aspect ratio of 20 or higher is counted and the percentage thereof is calculated.

The phrase “containing a non-fibrillated fibrillatable resin” more preferably means that the proportion of the number of fibrillatable resin particles having an aspect ratio of 10 or higher is 20% or lower relative to the total number of the fibrillatable resin particles. The proportion of the number of fibrillatable resin particles having an aspect ratio of 10 or higher relative to the total number of the fibrillatable resin particles is preferably 15% or lower, more preferably 10% or lower, still more preferably 5% or lower, further preferably 3% or lower, further more preferably 2% or lower, still further more preferably 1% or lower, particularly preferably 0.5% or lower.

The proportion of the number of fibrillatable resin particles having an aspect ratio of 10 or higher relative to the total number of the fibrillatable resin particles is determined by the following method.

A microscope is used to take an enlarged photograph of resin powder, whereby an image is obtained. The magnification may be, for example, 30× to 1000×.

The resulting image is saved in a computer and read by Image analysis software ImageJ.

The number of particles counted is set to 200 or more.

Of the resin particles counted, the number of resin particles having an aspect ratio of 10 or higher is counted and the percentage thereof is calculated.

The phrase “containing a non-fibrillated fibrillatable resin” still more preferably means that the proportion of the number of fibrillatable resin particles having an aspect ratio of 5 or higher is 20% or lower relative to the total number of the fibrillatable resin particles. The proportion of the number of fibrillatable resin particles having an aspect ratio of 5 or higher relative to the total number of the fibrillatable resin particles is preferably 15% or lower, more preferably 10% or lower, still more preferably 5% or lower, further preferably 3% or lower, further more preferably 2% or lower, still further more preferably 1% or lower, particularly preferably 0.5% or lower.

The proportion of the number of fibrillatable resin particles having an aspect ratio of 5 or higher relative to the total number of the fibrillatable resin particles is determined by the following method.

A microscope is used to take an enlarged photograph of resin powder, whereby an image is obtained. The magnification may be, for example, 30× to 1000×.

The resulting image is saved in a computer and read by Image analysis software ImageJ.

The number of particles counted is set to 200 or more.

Of the resin particles counted, the number of resin particles having an aspect ratio of 5 or higher is counted and the percentage thereof is calculated.

The fibrillatable resin has a glass transition temperature of preferably 10° C. or higher, more preferably 15° C. or higher, while preferably 35° C. or lower, more preferably 30° C. or lower, still more preferably 25° C. or lower.

Fibrillatable resins having a higher molecular weight are more easily fibrillatable. For example, the molecular weight is 50000 or higher, more preferably 100000 or higher, still more preferably 500000 or higher, further preferably 1000000 or higher. Specific examples thereof include polytetrafluoroethylene (PTFE), polyethylene, polyester, LCP, and acrylic resin. The fibrillatable resin preferably includes polyethylene, polyester, and polytetrafluoroethylene (PTFE), more preferably PTFE.

The binder powder for an electrochemical device of the disclosure contains the fibrillatable resin in an amount of preferably 50% by mass or more, more preferably 60% by mass or more, still more preferably 70% by mass or more, while preferably 99% by mass or less, more preferably 98% by mass or less, still more preferably 95% by mass or less.

The binder powder for an electrochemical device of the disclosure contains the PTFE in an amount of preferably 50% by mass or more, more preferably 60% by mass or more, still more preferably 70% by mass or more, while preferably 99% by mass or less, more preferably 98% by mass or less, still more preferably 95% by mass or less of the powder.

In order to achieve improved binding force, improved electrode strength, and improved electrode flexibility, the PTFE has a standard specific gravity (SSG) of preferably 2.200 or lower, more preferably 2.180 or lower, still more preferably 2.170 or lower, further preferably 2.160 or lower, further more preferably 2.150 or lower, still further more preferably 2.145 or lower, particularly preferably 2.140 or lower.

The SSG is also preferably 2.130 or higher.

The SSG is determined by the water displacement method in conformity with ASTM D792 using a sample formed in conformity with ASTM D4895.

The PTFE preferably has non-melt secondary processibility. The non-melt secondary processibility means a property of a polymer such that the melt flow rate is non-measurable at a temperature higher than the melting point in conformity with ASTM D1238 and D2116, in other words, a property such that the polymer does not easily flow even within a melting point range.

The PTFE may be a homopolymer of tetrafluoroethylene (TFE) or may be a modified PTFE containing a polymerized unit based on TFE (TFE unit) and a polymerized unit based on a modifying monomer (hereinafter, also referred to as a “modifying monomer unit”). The modified PTFE may contain 99.0% by mass or more of the TFE unit and 1.0% by mass or less of the modifying monomer unit. The modified PTFE may consist only of a TFE unit and a modifying monomer unit.

In order to achieve improved binding force, improved electrode strength, and improved electrode flexibility, the PTFE is preferably a modified PTFE.

In order to achieve improved stretchability, improved binding force, improved electrode strength, and improved electrode flexibility, the modified PTFE preferably contains a modifying monomer unit in an amount falling within a range of 0.00001 to 1.0% by mass of all polymerized units. The lower limit of the amount of the modifying monomer unit is more preferably 0.0001% by mass, still more preferably 0.001% by mass, further preferably 0.005% by mass, further more preferably 0.010% by mass. The upper limit of the amount of the modifying monomer unit is preferably 0.90% by mass, more preferably 0.50% by mass, still more preferably 0.40% by mass, further preferably 0.30% by mass, further more preferably 0.20% by mass, still further more preferably 0.15% by mass, particularly preferably 0.10% by mass.

The modifying monomer unit herein means a portion constituting the molecular structure of PTFE and derived from a modifying monomer.

The aforementioned amounts of the respective monomer units can be calculated by any appropriate combination of NMR, FT-IR, elemental analysis, and X-ray fluorescence analysis in accordance with the types of the monomers.

The modifying monomer may be any one copolymerizable with TFE, and examples thereof include perfluoroolefins such as hexafluoropropylene (HFP); hydrogen-containing fluoroolefins such as trifluoroethylene and vinylidene fluoride (VDF); perhaloolefins such as chlorotrifluoroethylene; perfluorovinyl ether; perfluoroallyl ether; (perfluoroalkyl)ethylenes, and ethylene. One modifying monomer may be used or multiple modifying monomers may be used.

The perfluorovinyl ether may be, but is not limited to, an unsaturated perfluoro compound represented by the following formula (A):

CF₂═CF—ORf (A)

(wherein Rf is a perfluoro organic group). The “perfluoro organic group” as used herein means an organic group obtained by replacing all hydrogen atoms binding to any of the carbon atoms by fluorine atoms. The perfluoro organic group optionally contains ether oxygen.

The perfluorovinyl ether may be, for example, a perfluoro(alkyl vinyl ether) (PAVE) represented by the formula (A) wherein Rf is a C1-C10 perfluoroalkyl group. The carbon number of the perfluoroalkyl group is preferably 1 to 5.

Examples of the perfluoroalkyl group in the PAVE include a perfluoromethyl group, a perfluoroethyl group, a perfluoropropyl group, a perfluorobutyl group, a perfluoropentyl group, and a perfluorohexyl group.

Examples of the perfluorovinyl ether also include:
one represented by the formula (A) wherein Rf is a C4-C9 perfluoro(alkoxyalkyl) group;
one represented by the formula (A) wherein Rf is a group represented by the following formula:

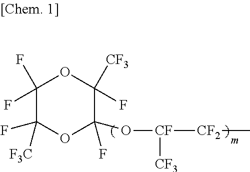

wherein m is 0 or an integer of 1 to 4; and
one represented by the formula (A) wherein Rf is a group represented by the following formula:

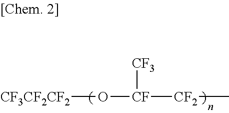

wherein n is an integer of 1 to 4.

Examples of the (perfluoroalkyl)ethylene (PFAE) include, but are not limited to, (perfluorobutyl)ethylene (PFBE) and (perfluorohexyl)ethylene.

The perfluoroallyl ether may be, for example, a fluoromonomer represented by the following formula (B):

CF₂═CF—CF₂—ORf¹ (B)

wherein Rf¹ is a perfluoro organic group.

Rf¹ is preferably a C1-C10 perfluoroalkyl group or a C1-C10 perfluoroalkoxyalkyl group. The perfluoroallyl ether preferably includes at least one selected from the group consisting of CF₂═CF—CF₂—O—CF₃, CF₂═CF—CF₂—O—C₂F₅, CF₂═CF—CF₂—O—C₃F₇, and CF₂═CF—CF₂—O—C₄F₉, more preferably at least one selected from the group consisting of CF₂═CF—CF₂—O—C₂F₅, CF₂═CF—CF₂—O—C₃F₇, and CF₂═CF—CF₂—O—C₄F₉, and is still more preferably CF₂═CF—CF₂—O—CF₂CF₂CF₃.

In order to achieve improved stretchability, improved binding force, and improved electrode flexibility, the modifying monomer preferably includes at least one selected from the group consisting of PAVE and HFP, more preferably at least one selected from the group consisting of perfluoro(methyl vinyl ether) (PMVE) and HFP.

The PTFE may have a core-shell structure. An example of the PTFE having a core-shell structure is a modified PTFE including, in the particle, a core of high-molecular-weight PTFE and a shell of lower-molecular-weight PTFE or modified PTFE. An example of such a modified PTFE is a PTFE disclosed in JP 2005-527652 T.

The PTFE has a peak temperature of preferably 333° C. to 347° C., more preferably 335° C. to 345° C. When multiple peak temperatures are present, at least one of these is preferably 340° C. or higher.

The peak temperature is the temperature corresponding to the maximum value on a heat-of-fusion curve drawn by increasing the temperature at a rate of 10° C./min using a differential scanning calorimeter (DSC) for a PTFE that has never been heated up to 300° C. or higher.

Preferably, the PTFE has at least one endothermic peak in a range of 333° C. to 347° C. on a heat-of-fusion curve drawn by increasing the temperature at a rate of 10° C./min using a differential scanning calorimeter (DSC) for a PTFE that has never been heated up to 300° C. or higher, and has an enthalpy of fusion of 62 mJ/mg or higher at 290° C. to 350° C. calculated from the heat-of-fusion curve.

The binder powder for an electrochemical device of the disclosure contains the thermoplastic polymer in an amount of preferably 0.5% by mass or more, more preferably 1% by mass or more, still more preferably 5% by mass or more, further preferably 10% by mass or more, while preferably 50% by mass or less, more preferably 40% by mass or less, still more preferably 30% by mass or less, further preferably 25% by mass or less of the powder.

The binder powder for an electrochemical device of the disclosure contains the thermoplastic polymer in an amount of preferably 1% by mass or more, more preferably 5% by mass or more, still more preferably 10% by mass or more, while preferably 100% by mass or less, more preferably 75% by mass or less, still more preferably 50% by mass or less, further preferably 40% by mass or less, particularly preferably 30% by mass or less of the fibrillatable resin.

The thermoplastic polymer may be a thermoplastic resin or may be an elastomer having a glass transition temperature of 25° C. or lower.

The thermoplastic resin has a melting point of preferably 100° C. or higher, more preferably 115° C. or higher, still more preferably 130° C. or higher, further preferably 160° C. or higher, further more preferably 210° C. or higher, still further more preferably 250° C. or higher, even more preferably 255° C. or higher, particularly preferably 295° C. or higher, while preferably lower than 324° C., more preferably 310° C. or lower, still more preferably 275° C. or lower, further preferably 270° C. or lower, further more preferably 230° C. or lower, still further more preferably 225° C. or lower, even more preferably 200° C. or lower, still even more preferably 180° C. or lower, particularly preferably 135° C. or lower.

The melting point herein is the temperature corresponding to the maximum value on a heat-of-fusion curve drawn by increasing the temperature as a second run at a rate of 10° C./min using a differential scanning calorimeter (DSC).

Examples of the thermoplastic resin include non-fluorinated polymers such as polyethylene, polypropylene, polyamide, polystyrene, thermoplastic polyurethane, polyimide, polyacrylate, polycarbonate, polylactic acid, polyether ether ketone, and polyethylene glycol; and fluoropolymers. The thermoplastic resin preferably includes polyethylene or a fluoropolymer, more preferably includes a fluoropolymer.

The thermoplastic resin has a melt flow rate of preferably 0.01 to 500 g/10 min or higher, more preferably 0.1 to 300 g/10 min or higher.

The melt flow rate is a value obtained as the mass (g/10 min) of a polymer that flows out of a nozzle having an inner diameter of 2 mm and a length of 8 mm per 10 minutes at a predetermined measurement temperature (e.g., 372° C. for PFA and FEP to be described later, 297° C. for ETFE) and load (e.g., 49 N (5 kg) for PFA, FEP, and ETFE) in accordance with the type of the fluoropolymer using a melt indexer in conformity with ASTM D1238.

Examples of the fluoropolymer include a tetrafluoroethylene (TFE)/perfluoro(alkyl vinyl ether) (PAVE) copolymer (PFA), a TFE/hexafluoropropylene (HFP) copolymer (FEP), an ethylene (Et)/TFE copolymer (ETFE), a TFE/HFP/VdF copolymer (THV), a VdF/TFE copolymer (VT), an Et/TFE/HFP copolymer (EFEP), polychlorotrifluoroethylene (PCTFE), a chlorotrifluoroethylene (CTFE)/TFE copolymer, an Et/CTFE copolymer, polyvinyl fluoride (PVF), and polyvinylidene fluoride (PVdF).

The PFA is preferably, but is not limited to, a copolymer having a mole ratio of a TFE unit to a PAVE unit (TFE unit/PAVE unit) of 70/30 or higher and lower than 99/1, more preferably 70/30 or higher and 98.9/1.1 or lower, still more preferably 80/20 or higher and 98.9/1.1 or lower, further preferably 90/10 or higher and 99.7/0.3 or lower, further more preferably 97/3 or higher and 99/1 or lower. Too small an amount of the TFE unit tends to cause reduced mechanical properties. Too large an amount thereof tends to cause too high a melting point and reduced moldability. The PFA is also preferably a copolymer containing 0.1 to 10 mol % of a monomer unit derived from a monomer copolymerizable with TFE and PAVE as well as 90 to 99.9 mol % in total of the TFE unit and the PAVE unit. Examples of the monomer copolymerizable with TFE and PAVE include HFP, a vinyl monomer represented by CZ³Z⁴═CZ⁵(CF₂)ₙZ⁶ (wherein Z³, Z⁴, and Z⁵ are the same as or different from each other and are each a hydrogen atom or a fluorine atom; Z⁶ is a hydrogen atom, a fluorine atom, or a chlorine atom; and n is an integer of 2 to 10), and an alkyl perfluorovinyl ether derivative represented by CF₂═CF—OCH₂—Rf⁷ wherein Rf⁷ is a C1-C5 perfluoroalkyl group).

The PFA has a melting point of preferably 180° C. or higher, more preferably 230° C. or higher, still more preferably 280° C. or higher, further preferably 290° C. or higher, particularly preferably 295° C. or higher, while preferably lower than 324° C., more preferably 320° C. or lower, still more preferably 310° C.

The FEP is preferably, but is not limited to, a copolymer having a mole ratio of a TFE unit to a HFP unit (TFE unit/HFP unit) of 70/30 or higher and lower than 99/1, more preferably 70/30 or higher and 98.9/1.1 or lower, still more preferably 80/20 or higher and 98.9/1.1 or lower. Alternatively, the FEP is preferably, but is not limited to, a copolymer having a mass ratio of a TFE unit to a HFP unit (TFE unit/HFP unit) of 60/40 or higher and 98/2 or lower, more preferably 60/40 or higher and 95/5 or lower, still more preferably 85/15 or higher and 92/8 or lower. The FEP may be further modified with a perfluoro(alkyl vinyl ether) as a monomer copolymerizable with TFE and HFP within a range of 0.1 to 2% by mass of all monomers. Too small an amount of the TFE unit tends to cause reduced mechanical properties. Too large an amount thereof tends to cause too high a melting point and reduced moldability. The FEP is also preferably a copolymer containing 0.1 to 10 mol % of a monomer unit derived from a monomer copolymerizable with TFE and HFP as well as 90 to 99.9 mol % in total of the TFE unit and the HFP unit. Examples of the monomer copolymerizable with TFE and HFP include PAVE and an alkyl perfluorovinyl ether derivative.

The FEP has a melting point that is lower than the melting point of the PTFE and is preferably 150° C. or higher, more preferably 200° C. or higher, still more preferably 240° C. or higher, further preferably 250° C. or higher, while preferably lower than 324° C., more preferably 320° C. or lower, still more preferably 300° C. or lower, further preferably 280° C. or lower, particularly preferably 275° C. or lower.

The ETFE is preferably a copolymer having a mole ratio of a TFE unit to an ethylene unit (TFE unit/ethylene unit) of 20/80 or higher and 90/10 or lower, more preferably 37/63 or higher and 85/15 or lower, still more preferably 38/62 or higher and 80/20 or lower. The mole ratio of the TFE unit to the ethylene unit (TFE unit/ethylene unit) may be 50/50 or higher and 99/1 or lower. The ETFE may be a copolymer containing TFE, ethylene, and a monomer copolymerizable with TFE and ethylene. Examples of the copolymerizable monomer include monomers represented by the following formulae:

CH₂═CX⁵Rf³,CF₂═CFRf³,CF₂═CFORf³, and CH₂═C(Rf³)₂

(wherein X⁵ is a hydrogen atom or a fluorine atom; and Rf³ is a fluoroalkyl group optionally containing an ether bond). Preferred among these are fluorine-containing vinyl monomers represented by CF₂═CFRf³, CF₂═CFORf³, and CH₂═CX⁵Rf³, more preferred are HFP, a perfluoro(alkyl vinyl ether) represented by CF₂═CF—ORf⁴ (wherein Rf⁴ is a C1-C5 perfluoroalkyl group), and a fluorine-containing vinyl monomer represented by CH₂═CX⁵Rf³ (wherein Rf³ is a C1-C8 fluoroalkyl group). The monomer copolymerizable with TFE and ethylene may be an aliphatic unsaturated carboxylic acid such as itaconic acid or an itaconic anhydride. The monomer copolymerizable with TFE and ethylene may be perfluorobutylethylene, 3,3,4,4,5,5,6,6,7,7,8,8,8-tridecafluorooct-1-ene, 2,3,3,4,4,5,5-heptafluoro-1-pentene (CH₂═CFCF₂CF₂CF₂H), or 2-trifluoromethyl-3,3,3-trifluoropropene ((CF₃)₂C═CH₂). The monomer copolymerizable with TFE and ethylene preferably represents 0.1 to 10 mol %, more preferably 0.1 to 5 mol %, particularly preferably 0.2 to 4 mol % of all polymerized units. The ETFE may be further modified with a monomer copolymerizable with TFE and ethylene in a range of 0 to 20% by mass of all monomers. Preferably, the ratio TFE:ethylene:monomer copolymerizable with TFE and ethylene is (63 to 94):(27 to 2):(1 to 10).

The ETFE may be a copolymer (EFEP) containing a TFE unit, an ethylene unit, and a HFP unit.

The EFEP has a mole ratio of the TFE unit to the ethylene unit of preferably 20:80 to 90:10, more preferably 37:63 to 85:15, still more preferably 38:62 to 80:20. The HFP unit preferably represents 0.1 to 30 mol %, more preferably 0.1 to 20 mol % of all polymerized units.

The ETFE preferably contains 20 to 80 mol % of the tetrafluoroethylene unit, 10 to 80 mol % of the ethylene unit, 0 to 30 mol % of the hexafluoropropylene unit, and 0 to 10 mol % of the other monomer(s).

The ETFE has a melting point of preferably 140° C. or higher, more preferably 160° C. or higher, still more preferably 195° C. or higher, further preferably 210° C. or higher, particularly preferably 215° C. or higher, while preferably lower than 324° C., more preferably 320° C. or lower, still more preferably 300° C. or lower, further preferably 280° C. or lower, particularly preferably 270° C. or lower.

The EFEP has a melting point of preferably 160° C. or higher while preferably 200° C. or lower.

The THV has a TFE/HFP/VdF copolymerization ratio (ratio by mol %) of preferably (75 to 95)/(0.1 to 10)/(0.1 to 19), more preferably (77 to 95)/(1 to 8)/(1 to 17) (mole ratio), still more preferably (77 to 95)/(2 to 8)/(2 to 16.5) (mole ratio), most preferably (77 to 90)/(3 to 8)/(5 to 16) (mole ratio). The TFE/HFP/VdF copolymer may contain 0 to 20 mol % of a different monomer. The different monomer may include at least one monomer selected from the group consisting of fluorine-containing monomers such as perfluoro(methyl vinyl ether), perfluoro(ethyl vinyl ether), perfluoro(propyl vinyl ether), chlorotrifluoroethylene, 2-chloropentafluoropropene, perfluorinated vinyl ether (e.g., perfluoroalkoxy vinyl ethers such as CF₃OCF₂CF₂CF₂OCF═CF₂), perfluoroalkyl vinyl ether, perfluoro-1,3-butadiene, trifluoroethylene, hexafluoroisobutene, vinyl fluoride, ethylene, propylene, alkyl vinyl ether, BTFB (H₂C═CH—CF₂—CF₂—Br), BDFE (F₂C═CHBr), and BTFE (F₂C—CFBr). Preferred are perfluoro(methyl vinyl ether), perfluoro(ethyl vinyl ether), perfluoro(propyl vinyl ether), BTFB (H₂C═CH—CF₂—CF₂—Br), BDFE (F₂C═CHBr), and BTFE (F₂C—CFBr).

The THV has a melting point of preferably 110° C. or higher, more preferably 140° C. or higher, still more preferably 160° C. or higher, further preferably 180° C. or higher, particularly preferably 220° C. or higher, while preferably 300° C. or lower, more preferably 270° C. or lower, still more preferably 250° C. or lower, further preferably 200° C. or lower, further more preferably 180° C. or lower, still further more preferably 160° C. or lower, particularly preferably 130° C. or lower.

The VT preferably contains a polymerized unit based on VdF (also referred to as a “VdF unit”) in an amount of 80.0 to 90.0 mol % of all polymerized units.

Less than 80.0 mol % of the VdF unit may cause a great change in viscosity of the electrode mixture over time. More than 90.0 mol % thereof tends to cause poor flexibility of an electrode to be obtained from the mixture.

The fluorine-containing polymer contains the VdF unit in an amount of preferably 80.5 mol % or more, more preferably 82.0 mol % or more of all polymerized units. More than 82.0 mol % or more thereof tends to cause better cycle characteristics of a battery including an electrode to be obtained from the electrode mixture of the disclosure.

The VT also contains the VdF unit in an amount of more preferably 89.0 mol % or less, still more preferably 88.9 mol % or less, particularly preferably 88.8 mol % or less of all polymerized units.

The VT contains a VdF unit and a polymerized unit based on TFE (also referred to as a “TFE unit”), and may optionally contain a polymerized unit based on a monomer copolymerizable with VdF and TFE. A copolymer of VdF and TFE is sufficient to achieve the effects of the disclosure. Still, a monomer copolymerizable therewith may be copolymerized such that the excellent swelling properties of the copolymer with a nonaqueous electrolyte solution are not impaired, more improving the adhesiveness.

The amount of the polymerized unit based on a monomer copolymerizable with VdF and TFE is preferably less than 3.0 mol % of all polymerized units of the VT. Not less than 3.0 mol % thereof typically tends to cause significantly reduced crystallinity of the copolymer of VdF and TFE, resulting in reduced swelling properties with a nonaqueous electrolyte solution.

The monomer copolymerizable with VdF and TFE include unsaturated dibasic acid monoesters as disclosed in JP H06-172452 A, such as monomethyl maleate, monomethyl citraconate, monoethyl citraconate, and vinylene carbonate; and compounds having a hydrophilic polar group such as —SO₃M, —OSO₃M, —COOM, —OPO₃M (where M is an alkali metal), or an amine-type polar group, e.g., —NHR¹ or —NR²R³ (where R¹, R², and R³ are each an alkyl group) as disclosed in JP H07-201316, such as CH₂═CH—CH₂—Y, CH₂═C(CH₃)—CH₂—Y, CH₂═CH—CH₂—O—CO—CH(CH₂COOR⁴)—Y, CH₂═CH—CH₂—O—CH₂—CH(OH)—CH₂—Y, CH₂═C(CH₃)—CO—O—CH₂—CH₂—CH₂—Y, CH₂═CH—CO—O—CH₂—CH₂—Y, and CH₂═CHCO—NH—C(CH₃)₂—CH₂—Y (where Y is a hydrophilic polar group; and R 4 is an alkyl group), as well as maleic acid and maleic anhydride. Examples of usable copolymerizable monomers also include hydroxylated allyl ether monomers such as CH₂═CH—CH₂—O—(CH₂)ₙ—OH (3≤n≤8),

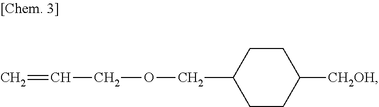

CH₂═CH—CH₂—O—(CH₂—CH₂—O)ₙ—H (1≤n≤14), and CH₂═CH—CH₂—O—(CH₂—CH(CH₃)—O)ₙ—H (1≤n≤14); allyl ether or ester monomers carboxylated and/or substituted with —(CF₂)ₙ—CF₃ (3≤n≤8), such as CH₂═CH—CH₂—O—CO—C₂H₄—COOH, CH₂═CH—CH₂—O—CO—C₅H₁₀—COOH, CH₂═CH—CH₂—O—C₂H₄—(CF₂)ₙCF₃, CH₂═CH—CH₂—CO—O—C₂H₄—(CF₂)ₙCF₃, and CH₂═C(CH₃)—CO—O—CH₂—CF₃.

Studies up to now enable analogical inference that those other than the compounds containing a polar group as described above can lead to improved adhesiveness to a current collector made of foil of metal such as aluminum or copper by slightly reducing the crystallinity of a copolymer of vinylidene fluoride and tetrafluoroethylene to give flexibility to the material. This enables the use of any of unsaturated hydrocarbon monomers (CH₂═CHR, wherein R is a hydrogen atom, an alkyl group, or a halogen such as C1) such as ethylene and propylene, and fluorine-based monomers such as ethylene chloride trifluoride, hexafluoropropylene, hexafluoroisobutene, 2,3,3,3-tetrafluoropropene, CF₂═CF—O—CₙF₂ₙ₊₁ (wherein n is an integer of 1 or greater), CH₂═CF—CₙF₂ₙ₊₁ (wherein n is an integer of 1 or greater), CH₂═CF—(CF₂CF₂)ₙH (wherein n is an integer of 1 or greater), and CF₂═CF—O—(CF₂CF(CF₃)O)ₘ—CₙF₂ₙ₊₁ (wherein m and n are each an integer of 1 or greater).

Also usable are fluorine-containing ethylenic monomers containing at least one functional group represented by the following formula (1):

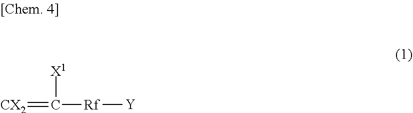

(wherein Y is —CH₂OH, —COOH, a carboxylic acid salt, a carboxy ester group, or an epoxy group; X and X¹ are the same as or different from each other and are each a hydrogen atom or a fluorine atom; and R f is a C1-C40 divalent fluorine-containing alkylene group or a C1-C40 divalent fluorine-containing alkylene group containing an ether bond). One or two or more of these monomers may be copolymerized to lead to much improved adhesiveness to a current collector, to prevent peeling of an electrode active material from the current collector even after repeated charge and discharge, and to lead to good charge and discharge cycle characteristics.

In terms of flexibility and chemical resistance, particularly preferred among these monomers are hexafluoropropylene and 2,3,3,3-tetrafluoropropene.

As described above, the VT contains a VdF unit and a TFE unit optionally as well as a different polymerized unit, and more preferably consists only of a VdF unit and a TFE unit.

The VT has a weight average molecular weight (polystyrene equivalent) of preferably 50000 to 2000000. The weight average molecular weight is more preferably 80000 or more, still more preferably 100000 or more, while more preferably 1950000 or less, still more preferably 1900000 or less, particularly preferably 1700000 or less, most preferably 1500000 or less.

The weight average molecular weight can be determined by gel permeation chromatography (GPC) at 50° C. using N,N-dimethylformamide as a solvent.

The VT has a number average molecular weight (polystyrene equivalent) of preferably 10000 to 1400000. The number average molecular weight is more preferably 16000 or more, still more preferably 20000 or more, while more preferably 1300000 or less, still more preferably 1200000 or less.

The number average molecular weight can be determined by gel permeation chromatography (GPC) at 50° C. using N,N-dimethylformamide as a solvent.

The VT has a melting point of preferably 120° C. or higher, more preferably 130° C. or higher, while preferably 150° C. or lower, more preferably 140° C. or lower, still more preferably 135° C. or lower.

The PVdF may be a homopolymer consisting only of a polymerized unit based on VdF or may include a polymerized unit based on VdF and a polymerized unit based on a monomer (a) copolymerizable with the polymerized unit based on VdF.

Examples of the monomer (a) include vinyl fluoride, trifluoroethylene, trifluorochloroethylene, fluoroalkyl vinyl ethers, hexafluoropropylene, 2,3,3,3-tetrafluoropropene, and propylene. Examples also include unsaturated dibasic acid monoesters disclosed in JP H06-172452 A, such as monomethyl maleate, monomethyl citraconate, monoethyl citraconate, and vinylene carbonate; and compounds having a hydrophilic polar group such as —SO₃M, —OSO₃M, —COOM, —OPO₃M (where M is an alkali metal), or an amine-type polar group, e.g., —NHR¹ or —NR²R³ (where R⁴, R², and R³ are each an alkyl group) as disclosed in JP H07-201316, such as CH₂═CH—CH₂—Y, CH₂═C(CH₃)—CH₂—Y, CH₂═CH—CH₂—O—CO—CH(CH₂COOR⁴)—Y, CH₂═CH—CH₂—O—CH₂—CH(OH)—CH₂—Y, CH₂═C(CH₃)—CO—O—CH₂—CH₂—CH₂—Y, CH₂═CH—CO—O—CH₂—CH₂—Y, and CH₂═CHCO—NH—C(CH₃)₂—CH₂—Y (where Y is a hydrophilic polar group; and R⁴ is an alkyl group), as well as maleic acid and maleic anhydride. Examples of usable copolymerizable monomers also include hydroxylated allyl ether monomers such as CH₂═CH—CH₂—O—(CH₂)ₙ—OH (3≤n≤8),

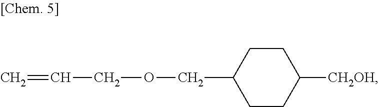

CH₂═CH—CH₂—O—(CH₂—CH₂—O)ₙ—H (1≤n≤14), and CH₂═CH—CH₂—O—(CH₂—CH(CH₃)—O)ₙ—H (1≤n≤14); allyl ether or ester monomers carboxylated and/or substituted with —(CF₂)ₙ—CF₃ (3≤n≤8), such as CH₂═CH—CH₂—O—CO—C₂H₄—COOH, CH₂═CH—CH₂—O—CO—C₅H₁₀—COOH, CH₂═CH—CH₂—O—C₂H₄—(CF₂)ₙCF₃, CH₂═CH—CH₂—CO—O—C₂H₄—(CF₂)ₙCF₃, and CH₂═C(CH₃)—CO—O—CH₂—CF₃. Studies up to now enable analogical inference that those other than the compounds containing a polar group as described above can lead to improved adhesiveness to a current collector made of foil of metal such as aluminum or copper by slightly reducing the crystallinity of PVdF to give flexibility to the material. This enables the use of any of unsaturated hydrocarbon monomers (CH₂═CHR, wherein R is a hydrogen atom, an alkyl group, or a halogen such as Cl) such as ethylene and propylene, and fluorine-based monomers such as ethylene chloride trifluoride, hexafluoropropylene, hexafluoroisobutene, CF₂═CF—O—CₙF₂ₙ₊₁ (wherein n is an integer of 1 or greater), CH₂═CF—CₙF₂ₙ₊₁ (wherein n is an integer of 1 or greater), CH₂═CF—(CF₂CF₂)ₙH (wherein n is an integer of 1 or greater), and CF₂═CF—O—(CF₂CF(CF₃)O)ₘ—CₙF₂ₙ₊₁ (wherein m and n are each an integer of 1 or greater).

Also usable are fluorine-containing ethylenic monomers containing at least one functional group represented by the formula (1):

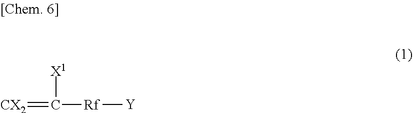

(wherein Y is —CH₂OH, —COOH, a carboxylic acid salt, a carboxy ester group, or an epoxy group; X and X¹ are the same as or different from each other and are each a hydrogen atom or a fluorine atom; and R f is a C1-C40 divalent fluorine-containing alkylene group or a C1-C40 divalent fluorine-containing alkylene group containing an ether bond). One or two or more of these monomers may be copolymerized to lead to much improved adhesiveness to a current collector, to prevent peeling of an electrode active material from the current collector even after repeated charge and discharge, and to lead to good charge and discharge cycle characteristics.

The PVdF contains a polymerized unit based on the monomer (α) in an amount of preferably 5 mol % or less, more preferably 4.5 mol % or less of all polymerized units.

The PVdF has a weight average molecular weight (polystyrene equivalent) of preferably 50000 to 2000000. The weight average molecular weight is more preferably 80000 or more, still more preferably 100000 or more, while more preferably 1700000 or less, still more preferably 1500000 or less.

The weight average molecular weight can be determined by gel permeation chromatography (GPC) at 50° C. using N,N-dimethylformamide as a solvent.

The PVdF has a number average molecular weight (polystyrene equivalent) of 150000 to 1400000.

PVdF having a number average molecular weight of less than 150000 may cause poor adhesiveness of an electrode to be obtained. PVdF having a number average molecular weight of more than 1400000 may cause easy gelation during preparation of an electrode mixture.

The number average molecular weight is preferably 200,000 or greater, more preferably 250,000 or greater, and even more preferably 300,000 or greater, and preferably 1,300,000 or smaller, more preferably 1,200,000 or smaller, further preferably 1,000,000, and particularly preferably 800,000.

The number average molecular weight can be determined by gel permeation chromatography (GPC) at 50° C. using N,N-dimethylformamide as a solvent.

The PVdF has a melting point of preferably 130° C. or higher, more preferably 150° C. or higher, still more preferably 160° C. or higher, while preferably 230° C. or lower, more preferably 200° C. or lower, still more preferably 180° C. or lower.

The aforementioned amounts of the respective monomer units of the copolymer can be calculated by any appropriate combination of NMR, FT-IR, elemental analysis, and X-ray fluorescence analysis in accordance with the types of the monomers.

In particular, the fluoropolymer preferably includes at least one selected from the group consisting of THV, VT, PVdF, ETFE, FEP, and PFA, more preferably at least one selected from the group consisting of THV, VT, PVdF, and EFEP, still more preferably at least one selected from the group consisting of THV and VT.

Examples of the elastomer having a glass transition temperature of 25° C. or lower include non-fluoroelastomers such as nitrile rubber, hydrogenated nitrile rubber, styrene-butadiene rubber (SBR), chloroprene rubber (CR), butadiene rubber (BR), natural rubber (NR), isoprene rubber (IR), ethylene-α-olefin rubber, ethylene-α-olefin-nonconjugated diene rubber, chlorinated polyolefin rubber, chlorosulfonated polyolefin rubber, acrylic rubber, ethylene acrylic rubber, epichlorohydrin rubber, silicone rubber, butyl rubber (IIR), ethylene-vinyl ester rubber, and ethylene-methacrylate rubber; and fluoroelastomers. The elastomer having a glass transition temperature of 25° C. or lower preferably includes a fluoroelastomer. The elastomer having a glass transition temperature of 25° C. or lower may be crosslinked or may be non-crosslinked.

Specific examples of the fluoroelastomer include a vinylidene fluoride (VdF)-based fluoroelastomer, a TFE/propylene (Pr)-based fluoroelastomer, a TFE/Pr/VdF-based fluoroelastomer, an ethylene (Et)/HFP-based fluoroelastomer, an Et/HFP/VdF-based fluoroelastomer, an Et/HFP/TFE-based fluorine-containing elastomer, a fluorosilicone-based fluorine-containing elastomer, and a fluorophosphazene-based fluorine-containing elastomer. These fluorine-containing elastomers may be used alone or in any combination, as long as they do not impair the effects of the disclosure. Of these, a VdF-based fluorine-containing elastomer is preferably used.

The VdF-based fluorine-containing elastomer is a fluorine-containing elastomer having a VdF unit and a different unit of a monomer copolymerizable with the VdF. The VdF-based fluorine-containing elastomer contains the VdF unit in an amount of preferably 20 mol % or more and 90 mol % or less, more preferably 40 mol % or more and 85 mol % or less of the total number of moles of the VdF unit and the different copolymerizable monomer unit. The lower limit is still more preferably 45 mol %, particularly preferably 50 mol %. The upper limit is still more preferably 80 mol %.

The comonomer in the VdF-based elastomer may be any one copolymerizable with VdF, and examples include fluorine-containing monomers such as tetrafluoroethylene (TFE), hexafluoropropylene (HFP), a perfluoroalkyl vinyl ether (PAVE), chlorotrifluoroethylene (CTFE), trifluoroethylene, trifluoropropylene, tetrafluoropropylene, pentafluoropropylene, trifluorobutene, tetrafluoroisobutene, hexafluoroisobutene, vinyl fluoride, an iodine-containing vinyl fluoride ether, a fluorine-containing monomer represented by the following formula (1-1):

CH₂═CFRf₁ (1-1)

(wherein Rf₁ is a C1-C12 linear or branched fluorinated alkyl or fluorinated alkoxy group optionally containing an oxygen atom between carbon-carbon atoms when the carbon number is 2 or greater); a fluorine-containing monomer represented by the following formula (2-1):

CHF═CHRf₂ (2-1)

wherein Rf₂ is a C1-C12 linear or branched fluorinated alkyl or fluorinated alkoxy group optionally containing an oxygen atom between carbon-carbon atoms when the carbon number is 2 or greater; fluorine-free monomers such as ethylene (Et), propylene (Pr), and an alkyl vinyl ether; a monomer that provides a crosslinkable group (cure site), and a reactive emulsifier. One of these monomers and compounds may be used or two or more thereof may be used in combination.

In the compound represented by the formula (1-1),

Rf₁ is a C1-C12 linear or branched fluorinated alkyl group or a C1-C12 linear or branched fluorinated alkoxy group. The fluorinated alkyl group and the fluorinated alkoxy group may each contain an oxygen atom (—O—) between carbon-carbon atoms when the carbon number is 2 or greater.

The fluorinated alkyl group of Rf₁ may be a partially fluorinated alkyl group in which a portion of the hydrogen atoms attached to any carbon atom are replaced by a fluorine atom, or may be a perfluorinated alkyl group in which all of the hydrogen atoms attached to any carbon atom are replaced by fluorine atoms. In the fluorinated alkyl group of Rf₁, a hydrogen atom may be replaced by a substituent other than a fluorine atom, but preferably contains no substituent other than a fluorine atom.

The fluorinated alkoxy group of Rf₁ may be a partially fluorinated alkoxy group in which a portion of the hydrogen atoms attached to any carbon atom are replaced by a fluorine atom, or may be a perfluorinated alkoxy group in which all of the hydrogen atoms attached to any carbon atom are replaced by fluorine atoms. In the fluorinated alkoxy group of Rf₁, a hydrogen atom may be replaced by a substituent other than a fluorine atom, but preferably contains no substituent other than a fluorine atom.

The carbon number of Rf₁ is preferably 1 to 10, more preferably 1 to 6, still more preferably 1 to 4, particularly preferably 1.

Rf₁ is preferably a group represented by the formula:

(Rf₁₁)m-(O)p-(Rf₁₂—O)n-Rf₁₃

wherein Rf₁₁ and Rf₁₂ are each independently a C1-C4 linear or branched fluorinated alkylene group; Rf₁₃ is a C1-C4 linear or branched fluorinated alkyl group; p is 0 or 1; m is an integer from 0 to 4; and n is an integer from 0 to 4.

The fluorinated alkylene group of Rf₁₁ and Rf₁₂ may be a partially fluorinated alkylene group in which a portion of the hydrogen atoms attached to any carbon atom are replaced by a fluorine atom, or may be a perfluorinated alkylene group in which all of the hydrogen atoms attached to any carbon atom are replaced by fluorine atoms. In the fluorinated alkylene group of Rf₁₁ and Rf₁₂, a hydrogen atom may be replaced by a substituent other than a fluorine atom, but preferably contains no substituent other than a fluorine atom. Rf₁₁ and Rf₁₂ may each be the same or different in each occurrence.

Examples of the fluorinated alkylene group of Rf₁₁ include —CHF—, —CF₂—, —CH₂—CF₂—, —CHF—CF₂—, —CF₂—CF₂—, —CF(CF₃)—, CH₂—CF₂—CF₂—, —CHF—CF₂—CF₂—, —CF₂—CF₂—CF₂—, —CF(CF₃)—CF₂—, —CF₂—CF(CF₃)—, —C(CF₃)₂—, —CH₂CF₂—CF₂—CF₂—, —CHF—CF₂CF₂CF₂—, —CF₂—CF₂CF₂CF₂—, —CH(CF₃)—CF₂—CF₂—, —CF(CF₃)—CF₂—CF₂—, and —C(CF₃)₂—CF₂—. Of these, a C1 or C2 perfluorinated alkylene group is preferred, with —CF₂— being more preferred.

Examples of the fluorinated alkylene group of Rf₁₂ include —CHF—, —CF₂—, —CH₂—CF₂—, —CHF—CF₂—, —CF₂—CF₂—, —CF(CF₃)—, CH₂—CF₂—CF₂—, —CHF—CF₂—CF₂—, —CF₂—CF₂—CF₂—, —CF(CF₃)—CF₂—, —CF₂—CF(CF₃)—, —C(CF₃)₂—, —CH₂CF₂—CF₂—CF₂—, —CHF—CF₂CF₂CF₂—, —CF₂—CF₂CF₂CF₂—, —CH(CF₃)—CF₂—CF₂—, —CF(CF₃)—CF₂—CF₂—, and —C(CF₃)₂—CF₂—. Of these, a C1 or C2 perfluorinated alkylene group is preferred, with —CF₂— being more preferred.

The fluorinated alkyl group of Rf₁₃ may be a partially fluorinated alkyl group in which a portion of the hydrogen atoms attached to any carbon atom is replaced by a fluorine atom, or may be a perfluorinated alkyl group in which all of the hydrogen atoms attached to any carbon atom are replaced by fluorine atoms. In the fluorinated alkyl group of Rf₁₃, a hydrogen atom may be replaced by a substituent other than a fluorine atom, but preferably contains no substituent (e.g., —CN, —CH₂I, or —CH₂Br) other than a fluorine atom.

Examples of the fluorinated alkyl group of Rf₁₃ include —CH₂F, —CHF₂, —CF₃, —CH₂—CH₂F, —CH₂—CHF₂, —CH₂—CF₃, —CHF—CH₂F, —CHF—CHF₂, —CHF—CF₃, —CF₂—CH₂F, —CF₂—CHF₂, —CF₂—CF₃, —CH₂—CF₂—CH₂F, —CHF—CF₂—CH₂F, —CF₂—CF₂—CH₂F, —CF(CF₃)—CH₂F, —CH₂—CF₂—CHF₂, —CHF—CF₂—CHF₂, —CF₂—CF₂—CHF₂, —CF(CF₃)—CHF₂, —CH₂—CF₂—CF₃, —CHF—CF₂—CF₃, —CF₂—CF₂—CF₃, —CF(CF₃)—CF₃, —CH₂—CF₂—CF₂—CF₃, —CHF—CF₂—CF₂—CF₃, —CF₂—CF₂—CF₂—CF₃, —CH(CF₃)—CF₂—CF₃, —CF(CF₃)—CF₂—CF₃, and —C(CF₃)₂—CF₃. Of these, —CF₃, —CHF—CF₃, —CF₂—CHF₂, —CF₂—CF₃, —CF₂—CF₂—CF₃, —CF(CF₃)—CF₃, —CF₂—CF₂—CF₂—CF₃, —CH(CF₃)—CF₂—CF₃, or —CF(CF₃)—CF₂—CF₃ is preferred.

In the formula, p is preferably 0.

In the formula, m is preferably an integer from 0 to 2, more preferably 0 or 1, still more preferably 0. When p is 0, m is also preferably 0.

In the formula, n is preferably an integer from 0 to 2, more preferably 0 or 1, still more preferably 0.

The repeating unit is preferably

—CH₂—CF[—CF₃]—,

—CH₂—CF[—CF₂CF₃]—,

—CH₂—CF[CF₂CF₂CF₃]—,

—CH₂—CF[CF₂CF₂CF₂CF₃]—,

—CH₂—CF[—CF₂—O—CF(CF₃)—CF₂—O—CHF—CF₃]—,

—CH₂—CF[—CF₂—O—CF(CF₃)—CF₂—O—CF₂—CF₃]—,

—CH₂CF[—CF₂—O—CF(CF₃)—CF₂—O—CF(CF₃)—CF₃]—,

—CH₂—CF[—CF₂—O—CF(CF₃)—CF₂O—CH(CF₃)—CF₂—CF₃]—,

—CH₂—CF[—CF₂—O—CF(CF₃)—CF₂—O—CF(CF₃)—CF₂—CF₃]—,

—CH₂—CF[—OCF₂OCF₃]—,

—CH₂—CF[—OCF₂CF₂CF₂2OCF₃]—,

—CH₂—CF[—CF₂OCFOCF₃]—,

—CH₂—CF[—CF₂OCF₂CF₂CF₂OCF₃]—, or

—CH₂—CF[—O—CF₂—CF₃]—,

with —CH₂—CF[—CF₃]— being more preferred.

In the compound represented by the formula (2-1),

Rf₂ is a C1-C12 linear or branched fluorinated alkyl group or a C1-C12 linear or branched fluorinated alkoxy group. The fluorinated alkyl group and the fluorinated alkoxy group may each contain an oxygen atom (—O—) between carbon-carbon atoms when the carbon number is 2 or greater.

The fluorinated alkyl group of Rf₂ may be a partially fluorinated alkyl group in which a portion of the hydrogen atoms attached to any carbon atom are replaced by a fluorine atom, or may be a perfluorinated alkyl group in which all of the hydrogen atoms attached to any carbon atom are replaced by fluorine atoms. In the fluorinated alkyl group of Rf₂, a hydrogen atom may be replaced by a substituent other than a fluorine atom, but preferably contains no substituent other than a fluorine atom.

The fluorinated alkoxy group of Rf₂ may be a partially fluorinated alkoxy group in which a portion of the hydrogen atoms attached to any carbon atom are replaced by a fluorine atom, or may be a perfluorinated alkoxy group in which all of the hydrogen atoms attached to any carbon atom are replaced by fluorine atoms. In the fluorinated alkoxy group of Rf₂, a hydrogen atom may be replaced by a substituent other than a fluorine atom, but preferably contains no substituent other than a fluorine atom.

The carbon number of Rf₂ is preferably 1 to 10, more preferably 1 to 6, still more preferably 1 to 4, particularly preferably 1.

Rf₂ is preferably a group represented by the formula:

—(Rf₂₁)m-(O)p-(Rf₂₂—O)n-Rf₂₃

wherein Rf₂₁ and Rf₂₂ are each independently a C1-C4 linear or branched fluorinated alkylene group; Rf₂₃ is a C1-C4 linear or branched fluorinated alkyl group; p is 0 or 1; m is an integer from 0 to 4; and n is an integer from 0 to 4.

The fluorinated alkylene group of Rf₂₁ and Rf₂₂ may be a partially fluorinated alkylene group in which a portion of the hydrogen atoms attached to any carbon atom are replaced by a fluorine atom, or may be a perfluorinated alkylene group in which all of the hydrogen atoms attached to any carbon atom are replaced by fluorine atoms. In the fluorinated alkylene group of Rf₂₁ and Rf₂₂, a hydrogen atom may be replaced by a substituent other than a fluorine atom, but preferably contains no substituent other than a fluorine atom. Rf₂₁ and Rf₂₂ may each be the same or different in each occurrence.

Examples of the fluorinated alkylene group of Rf₂₁ include —CHF—, —CF₂—, —CH₂—CF₂—, —CHF—CF₂—, —CF₂—CF₂—, —CF(CF₃)—, —CH₂—CF₂—CF₂—, CHF—CF₂CF₂—, —CF₂—CF₂—CF₂—, —CF(CF₃)—CF₂—, —CF₂—CF(CF₃)—, —C(CF₃)₂—, —CH₂CF₂CF₂CF₂—, —CHF—CF₂CF₂CF₂CF₂—CF₂—CF₂—CF₂—, —CH(CF₃)—CF₂—CF₂—, —CF(CF₃)—CF₂—CF₂—, and —C(CF₃)₂—CF₂—. Of these, a C1 or C2 perfluorinated alkylene group is preferred, with —CF₂— being more preferred.

Examples of the fluorinated alkylene group of Rf₂₂ include —CHF—, —CF₂—, —CH₂—CF₂—, —CHF—CF₂—, —CF₂—CF₂—, —CF(CF₃)—, —CH₂—CF₂—CF₂—, —CHF—CF₂CF₂—, —CF₂—CF₂—CF₂—, —CF(CF₃)—CF₂—, —CF₂—CF(CF₃)—, —C(CF₃)₂—, —CH₂CF₂CF₂CF₂—, —CHF—CF₂CF₂CF₂—, —CF₂—CF₂—CF₂—CF₂—, —CH(CF₃)—CF₂—CF₂—, —CF(CF₃)—CF₂—CF₂—, and —C(CF₃)₂—CF₂—. Of these, a C1-C3 perfluorinated alkylene group is preferred, with —CF₂—, —CF₂CF₂—, —CF₂—CF₂—CF₂—, —CF(CF₃)—CF₂—, or —CF₂—CF(CF₃)— being more preferred.

The fluorinated alkyl group of Rf₂₃ may be a partially fluorinated alkyl group in which a portion of the hydrogen atoms attached to any carbon atom is replaced by a fluorine atom, or may be a perfluorinated alkyl group in which all of the hydrogen atoms attached to any carbon atom are replaced by fluorine atoms. In the fluorinated alkyl group of Rf₂₃, a hydrogen atom may be replaced by a substituent other than a fluorine atom, but preferably contains no substituent (e.g., —CN, —CH₂I, or —CH₂Br) other than a fluorine atom.

Examples of the fluorinated alkyl group of Rf₂₃ include —CH₂F, —CHF₂, —CF₃, —CH₂—CH₂F, —CH₂—CHF 2, —CH₂—CF₃, —CHF—CH₂F, —CHF—CHF₂, —CHF—CF₃, —CF₂—CH₂F, —CF₂—CHF₂, —CF₂—CF₃, —CH₂—CF₂—CH₂F, —CHF—CF₂—CH₂F, —CF₂—CF₂—CH₂F, —CF(CF₃)—CH₂F, —CH₂—CF₂—CHF₂, —CHF—CF₂—CHF₂, —CF₂—CF₂—CHF₂, —CF(CF₃)—CHF₂, —CH₂—CF₂—CF₃, —CHF—CF₂—CF₃, —CF₂—CF₂—CF₃, —CF(CF₃)—CF₃, —CH₂—CF₂—CF₂—CF₃, —CHF—CF₂—CF₂—CF₃, —CF₂—CF₂—CF₂—CF₃, —CH(CF₃)—CF₂—CF₃, —CF(CF₃)—CF₂—CF₃, and —C(CF₃)₂—CF₃. Of these, —CF₃, —CHF—CF₃, —CF₂—CHF 2, —CF₂—CF₃, —CF₂—CF₂—CF₃, —CF(CF₃)—CF₃, —CF₂—CF₂—CF₂—CF₃, —CH(CF₃)—CF₂—CF₃, or —CF(CF₃)—CF₂—CF₃ is preferred.

In the formula, p is preferably 0.

In the formula, m is preferably an integer from 0 to 2, more preferably 0 or 1, still more preferably 0. When p is 0, m is also preferably 0.

In the formula, n is preferably an integer from 0 to 2, more preferably 0 or 1, still more preferably 0.

The repeating unit is preferably

—CHF—CH[—CF₃]—,

—CHF—CH[—CF₂CF₃]—,

—CHF—CH[—CF₂CF₂CF₃]—, or

—CHF—CH[—CF₂CF₂CF₂CF₃]—,

with —CHF—CH[—CF₃]— being more preferred.

In particular, the copolymerized units are preferably derived from hexafluoropropylene (HFP), tetrafluoroethylene (TFE), 2,3,3,3-tetrafluoropropylene, 1,3,3,3-tetrafluoropropylene, and a perfluoroalkyl vinyl ether (PAVE). Most preferably, at least part of the copolymerized units is derived from hexafluoropropylene (HFP). Examples of vinylidene fluoride-based elastomers in which at least part of the copolymerized units is derived from hexafluoropropylene (HFP) include a binary elastomer containing vinylidene fluoride and hexafluoropropylene, and a ternary elastomer containing vinylidene fluoride, tetrafluoroethylene, and hexafluoropropylene.

The PAVE is more preferably perfluoro(methyl vinyl ether) (PMVE) or perfluoro(propyl vinyl ether) (PPVE), with PMVE being particularly preferred.

The PAVE used may also be a perfluorovinyl ether represented by the formula:

CF₂═CFOCF₂ORf^{c}

(wherein Rf^{c} is a C1-C6 linear or branched perfluoroalkyl group, a C5 or C6 cyclic perfluoroalkyl group, or a C2-C₆ linear or branched perfluorooxyalkyl group containing 1 to 3 oxygen atoms). Preferably used among these is CF₂═CFOCF₂OCF₃, CF₂═CFOCF₂OCF₂CF₃, or CF₂═CFOCF₂OCF₂CF₂OCF₃.

The VdF-based fluorine-containing elastomer preferably includes at least one copolymer selected from the group consisting of a VdF/HFP copolymer, a VdF/TFE/HFP copolymer, a VdF/CTFE copolymer, a VdF/CTFE/TFE copolymer, a VdF/PAVE copolymer, a VdF/TFE/PAVE copolymer, a VdF/HFP/PAVE copolymer, a VdF/HFP/TFE/PAVE copolymer, a VdF/TFE/Pr copolymer, a VdF/Et/HFP copolymer, and a copolymer of VdF and a fluorine-containing monomer represented by the formula (1-1) or (2-1). The VdF-based fluorine-containing elastomer more preferably has at least one comonomer selected from the group consisting of TFE, HFP, and a PAVE as a comonomer other than VdF.

Of these, preferred is at least one copolymer selected from the group consisting of a VdF/HFP copolymer, a VdF/TFE/HFP copolymer, a copolymer of VdF and a fluoromonomer represented by the formula (1-1) or (2-1), a VdF/PAVE copolymer, a VdF/TFE/PAVE copolymer, a VdF/HFP/PAVE copolymer, and a VdF/HFP/TFE/PAVE copolymer; more preferred is at least one copolymer selected from the group consisting of a VdF/HFP copolymer, a VdF/TFE/HFP copolymer, a copolymer of VdF and a fluoromonomer represented by the formula (1-1) or (2-1), and a VdF/PAVE copolymer; and particularly preferred is at least one copolymer selected from the group consisting of a VdF/HFP copolymer, a VdF/TFE/HFP copolymer, and a VdF/PAVE copolymer.

The VdF/HFP copolymer has a VdF/HFP composition of preferably (45 to 85)/(55 to 15) (mol %), more preferably (50 to 80)/(50 to 20) (mol %), still more preferably (60 to 80)/(40 to 20) (mol %). The VdF/HFP composition is also preferably (50 to 78)/(50 to 22) (mol %).

The VdF/TFE/HFP copolymer has a VdF/TFE/HFP composition of preferably (30 to 80)/(4 to 35)/(10 to 35) (mol %).

The VdF/PAVE copolymer has a VdF/PAVE composition of preferably (65 to 90)/(35 to 10) (mol %). In a preferred embodiment, the VdF/PAVE composition may be (50 to 78)/(50 to 22) (mol %).

The VdF/TFE/PAVE copolymer has a VdF/TFE/PAVE composition of preferably (40 to 80)/(3 to 40)/(15 to 35) (mol %).

The VdF/HFP/PAVE copolymer has a VdF/HFP/PAVE composition of preferably (65 to 90)/(3 to 25)/(3 to 25) (mol %).

The VdF/HFP/TFE/PAVE copolymer has a VdF/HFP/TFE/PAVE composition of preferably (40 to 90)/(0 to 25)/(0 to 40)/(3 to 35) (mol %), more preferably (40 to 80)/(3 to 25)/(3 to 40)/(3 to 25) (mol %).

In the copolymer of VdF and a fluorine-containing monomer (1-1) or (2-1) represented by the formula (1-1) or (2-1) the ratio of VdF/unit of fluorine-containing monomer (1-1) or (2-1) is preferably 87/13 to 20/80 (mol %) and a different monomer unit other than VdF and the fluorine-containing monomer (1-1) or (2-1) preferably represents 0 to 50 mol % of all monomer units. The mol % ratio of VdF/unit of fluorine-containing monomer (1-1) or (2-1) is more preferably 80/20 to 20/80. In a preferred embodiment, the composition of VdF/unit of fluorine-containing monomer (1-1) or (2-1) may be 78/22 to 50/50 (mol %). Alternatively, preferably, the ratio of VdF/unit of fluorine-containing monomer (1-1) or (2-1) is 87/13 to 50/50 (mol %) and a different monomer unit other than VdF and the fluorine-containing monomer (1-1) or (2-1) represents 1 to 50 mol % of all monomer units. Preferred examples of the different monomer other than VdF and the fluorine-containing monomer (1-1) or (2-1) include the monomers mentioned as examples of the comonomer of VdF, such as TFE, HFP, PMVE, perfluoroethyl vinyl ether (PEVE), PPVE, CTFE, trifluoroethylene, hexafluoroisobutene, vinyl fluoride, Et, Pr, an alkyl vinyl ether, a monomer that provides a crosslinkable group, and a reactive emulsifier, with PMVE, CTFE, HFP, and TFE being more preferred.

The TFE/Pr-based fluorine-containing elastomer refers to a fluorine-containing copolymer containing 45 to 70 mol % of TFE and 55 to 30 mol % of Pr. In addition to these two components, the elastomer may contain 0 to 40 mol % of a specific third component (e.g., PAVE).

The Et/HFP copolymer has a Et/HFP composition of preferably (35 to 80)/(65 to 20) (mol %), more preferably (40 to 75)/(60 to 25) (mol %).

The Et/HFP/TFE copolymer has a Et/HFP/TFE composition of preferably (35 to 75)/(25 to 50)/(0 to 15) (mol %), more preferably (45 to 75)/(25 to 45)/(0 to 10) (mol %).

Examples of perfluoroelastomers include those containing TFE/PAVE. The TFE/PAVE composition is preferably (50 to 90)/(50 to 10) (mol %), more preferably (50 to 80)/(50 to 20) (mol %), still more preferably (55 to 75)/(45 to 25) (mol %).

In this case, examples of the PAVE include PMVE and PPVE, which can be used alone or in any combination.

The fluoroelastomer has a fluorine content of preferably 50% by mass or more, more preferably 55% by mass or more, still more preferably 60% by mass or more. The upper limit of the fluorine content is preferably, but not limited to, 71% by mass or less.

The fluorine content is the value calculated from the composition of the fluoroelastomer determined by ¹⁹F-NMR.

The fluorine content is calculated by calculating the molecular weight from the composition ratio and determining the mass of the fluorine atoms contained therein.

The compositional proportion of each repeating unit of the fluoroelastomer herein is a value determined by NMR. Specifically, the value is determined by the following solution NMR method.

Measurement apparatus: VNMRS400, available from Varian Inc. Resonance frequency: 376.04 (Sfrq)

Pulse width: 30° (pw=6.8)

The non-perfluorinated fluorine-containing elastomer and the perfluorinated fluorine-containing elastomer described above can be produced by a conventional technique such as emulsion polymerization, suspension polymerization, or solution polymerization. In particular, a polymerization technique using an iodine (bromine) compound, which is known as iodine (bromine) transfer polymerization, can produce a fluoroelastomer having a narrow molecular weight distribution.

The polymer may have a structural unit other than the vinylidene fluoride unit and the copolymerized unit (A). In this case, the amount of the structural unit is preferably 50 mol % or less. Alternatively, the polymer may consist only of the vinylidene fluoride unit and the copolymerized unit (A). The amount of the structural unit is more preferably 30 mol % or less, still more preferably 15 mol % or less.

In the polymer, the different monomer may be a monomer that provides a crosslinking site.

Any monomer that provides a crosslinking site may be used. Examples of monomers to be used as the different monomer include:

an iodine- or bromine-containing monomer represented by the formula:

CX¹₂═CX¹—Rf₁CHR¹X²

wherein X¹ is a hydrogen atom, a fluorine atom, or —CH₃; Rf¹ is a fluoroalkylene group, a perfluoroalkylene group, a fluoro(poly)oxyalkylene group, or a perfluoro(poly)oxyalkylene group; R¹ is a hydrogen atom or —CH₃; and X² is an iodine atom or a bromine atom;
a monomer represented by the formula:

CF₂═CFO(CF₂CF(CF₃)O)m(CF₂)n-X³

wherein m is an integer from 0 to 5; n is an integer from 1 to 3; and X³ is a cyano group, a carboxyl group, an alkoxycarbonyl group, an iodine atom, or a bromine atom; and
a monomer represented by the formula:

CH₂═CFCF₂O(CF(CF₃)CF₂O)m(CF(CF₃))n-X⁴

wherein m is an integer from 0 to 5; n is an integer from 1 to 3; and X⁴ is a cyano group, a carboxyl group, an alkoxycarbonyl group, an iodine atom, a bromine atom, or —CH₂OH.

Of these, preferred is at least one selected from the group consisting of CF₂═CFOCF₂CF(CF₃)OCF₂CF₂CN, CF₂═CFOCF₂CF(CF₃)OCF₂CF₂COOH, CF₂═CFOCF₂CF₂CH₂I, CF₂═CFOCF₂CF(CF₃)OCF₂CF₂CH₂I, CH₂═CFCF₂OCF(CF₃)CF₂OCF(CF₃)CN, CH₂═CFCF₂OCF(CF₃)CF₂OCF(CF₃) COOH, and CH₂═CFCF₂OCF(CF₃)CF₂OCF(CF₃)CH₂OH. The polymer may contain a repeating unit derived from a monomer that provides a crosslinking site. Still, in an embodiment of the disclosure, the polymer contains no crosslinking agent.

In order to achieve good adhesiveness and good flexibility as well as good solubility in a solvent, the fluoroelastomer has a number average molecular weight (Mn) of preferably 7000 to 5000000, has a mass average molecular weight (Mw) of preferably 10000 to 10000000, and has a Mw/Mn of preferably 1.0 to 30.0, more preferably 1.5 to 25.0. The number average molecular weight (Mn), the mass average molecular weight (Mw), and the Mw/Mn are the values determined by the GPC method.

The fluoroelastomer has a Mooney viscosity (ML1+10 (121° C.)) at 121° C. of preferably 2 or higher, more preferably 5 or higher, still more preferably 10 or higher, particularly preferably 30 or higher. This Mooney viscosity may be 200 or lower. The fluoroelastomer has a Mooney viscosity (ML1+10 (140° C.)) at 140° C. of preferably 2 or higher, more preferably 5 or higher, still more preferably 10 or higher, particularly preferably 30 or higher. This Mooney viscosity may be 200 or lower. The Mooney viscosity is the value determined in accordance with ASTM D1646-15 and JIS K6300-1:2013.

The fluoroelastomer preferably has an end structure that satisfies the following inequality:

0.01≤([—CH₂OH]+[—COOH])/([—CH₃]+[—CF₂H]+[—CH₂OH]+[—CH₂I]+[—OC(O)RH]+[—COOH])≤0.25

(wherein RH is a C1-C20 alkyl group). An end functional group satisfying the above inequality can lead to good adhesiveness and good flexibility, resulting in excellent functions.

Satisfying the above inequality means not that the fluorocopolymer contains all functional groups [—CH₃], [—CF₂H], [—CH₂OH], [—CH₂I], [—OC(O)RH], and [—COOH] but that the number ratio of the end groups present in the fluorocopolymer among these falls within the aforementioned range.

The amounts of the respective end groups of the fluorocopolymer can be determined by NMR analysis.

For example, NMR analysis of end groups may be performed by proton solution NMR. An analysis sample for determination is prepared as a 20% by mass solution of a sample in an Acetone-d6 solvent.

For the standard peak, the peak top of acetone was 2.05 ppm.

Measurement apparatus: VNMRS400, available from Varian Inc.
Resonance frequency: 399.74 (Sfrq)
Pulse width: 45°

The ends correspond to the following groups at the following respective peak positions.

[—CH₃]:1.72 to 1.86 ppm

[—CF₂H]:6.1 to 6.8 ppm

[—CH₂OH]:3.74 to 3.80 ppm

[—CH₂I]:3.87 to 3.92 ppm

[—OC(O)RH]:1.09 to 1.16 ppm

[—COOH]:10 to 15 ppm

Base on the integrals of the respective peaks specified by the aforementioned measurement, the peak intensities are used to calculate the amounts of the functional groups. Based on the results thereof, the ratio is calculated by the following expression.

([—CH₂OH]+[—COOH])/([—CH₃]+[—CF₂H]+[—CH₂OH]+[—CH₂I]+[—OC(O)RH]+[—COOH])

The values [—CH₂OH] and [—COOH] may be controlled to fall within the aforementioned predetermined ranges by any method, such as a known method (e.g., selection of an initiator used for polymerization and the amount thereof).

The fluoropolymer can be produced by a common radical polymerization. The form of polymerization may be any of bulk polymerization, solution polymerization, suspension polymerization, and emulsion polymerization. In order to easily perform the polymerization on an industrial scale, emulsion polymerization is preferred.

In the polymerization, a polymerization initiator, a chain transfer agent, a surfactant, and a solvent may be used, and these components used may be conventionally known ones.

The copolymer may be in any form, such as an aqueous dispersion or powder. In the case of emulsion polymerization, the copolymer in the form of powder can be obtained by coagulating a dispersion immediately after the polymerization, washing the resulting product with water, and dehydrating and drying the product. The coagulation can be achieved by adding an inorganic acid such as aluminum sulfate or an inorganic salt, by applying mechanical shear force, or by freezing the dispersion. In the case of suspension polymerization, the copolymer in the form of powder can be obtained by collecting the copolymer from the dispersion immediately after the polymerization and drying the copolymer. In the case of solution polymerization, the copolymer in the form of powder can be obtained by directly evaporating a solution containing the fluorine-containing polymer or by adding a poor solvent dropwise for purification.

The binder powder for an electrochemical device of the disclosure has a water content of preferably 1000 ppm by mass or less. The water content is more preferably 500 ppm by mass or less, still more preferably 200 ppm by mass or less, further preferably 100 ppm by mass or less, further more preferably 50 ppm by mass or less, particularly preferably 10 ppm by mass or less.

The water content is determined by the following method.

The mass of the binder powder for an electrochemical device is weighed before and after heating at 150° C. for two hours, and the water content is calculated by the following formula. The sample is taken three times and this calculation is performed for each sample and the values are averaged. This average is taken as the water content.

Water content (ppm by mass)=[(mass (g) of binder powder for electrochemical device before heating)−(mass (g) of binder powder for electrochemical device after heating)]/(mass (g) of binder powder for electrochemical device before heating)×1000000

The binder powder for an electrochemical device of the disclosure has an average primary particle size of preferably 10 to 500 nm. The average primary particle size is preferably 350 nm or smaller, more preferably 330 nm or smaller, still more preferably 320 nm or smaller, further preferably 300 nm or smaller, further more preferably 280 nm or smaller, particularly preferably 250 nm or smaller, while preferably 100 nm or greater, more preferably 150 nm or greater, still more preferably 170 nm or greater, particularly preferably 200 nm or greater.

The average primary particle size is determined by dynamic light scattering.

The binder powder for an electrochemical device is irradiated at 100 to 300 kGy and pulverized into fine particles using a pulverizer. The fine particles were combined with water and a nonionic surfactant and the components were sonicated such that the fine particles do not coagulate, whereby a dispersion is obtained. The average primary particle size can be determined by dynamic light scattering at 25° C. with 70 accumulations on an aqueous dispersion adjusted to have a solid concentration of about 1.0% by mass, with a solvent (water) having a refractive index of 1.3328 and a viscosity of 0.8878 mPa·s. The dynamic light scattering may be performed using ELSZ-1000S (available from Otsuka Electronics Co., Ltd.), for example.

The binder powder for an electrochemical device of the disclosure has a maximum particle size of preferably smaller than 2000 μm. The maximum particle size is more preferably 1500 μm or smaller, still more preferably 1300 μm or smaller, further preferably 1000 μm or smaller. The maximum particle size is preferably 300 μm or greater.

The maximum particle size is determined by the following method.

The maximum particle size is defined as the particle size D90 that corresponds to 90% by weight cumulation in the particle size distribution determined in conformity with JIS Z8815.

For the binder powder for an electrochemical device of the disclosure, the proportion of the number of fibrillatable resin particles having an aspect ratio of 30 or higher is preferably 20% or lower relative to the total number of the fibrillatable resin particles. The proportion of the number of fibrillatable resin particles having an aspect ratio of 30 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 30 or higher relative to the total number of the fibrillatable resin particles can be determined by the aforementioned method.

For the binder powder for an electrochemical device of the disclosure, the proportion of the number of fibrillatable resin particles having an aspect ratio of 20 or higher is preferably 20% or lower relative to the total number of the fibrillatable resin particles. The proportion of the number of fibrillatable resin particles having an aspect ratio of 20 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 20 or higher relative to the total number of the fibrillatable resin particles can be determined by the aforementioned method.

For the binder powder for an electrochemical device of the disclosure, the proportion of the number of fibrillatable resin particles having an aspect ratio of 10 or higher is preferably 20% or lower relative to the total number of the fibrillatable resin particles. The proportion of the number of fibrillatable resin particles having an aspect ratio of 10 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 10 or higher relative to the total number of the fibrillatable resin particles can be determined by the aforementioned method.

For the binder powder for an electrochemical device of the disclosure, the proportion of the number of fibrillatable resin particles having an aspect ratio of 5 or higher is preferably 20% or lower relative to the total number of the fibrillatable resin particles. The proportion of the number of fibrillatable resin particles having an aspect ratio of 5 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 5 or higher relative to the total number of the fibrillatable resin particles can be determined by the aforementioned method.

In the binder powder for an electrochemical device of the disclosure, the non-fibrillated fibrillatable resin and the thermoplastic polymer are preferably mixed with each other, more preferably uniformly mixed with each other. Uniform mixing can be confirmed by the following average particle size, for example.

The binder powder for an electrochemical device has an average particle size of preferably 1000 μm or smaller, more preferably 800 μm or smaller, while preferably 200 μm or greater, more preferably 300 μm or greater.

The average particle size can be determined in conformity with JIS 28815.

The binder powder for an electrochemical device of the disclosure may be produced by, for example, a production method including a step (1) of preparing a mixture containing the fibrillatable resin, the thermoplastic polymer, and water, and a step (2) of producing a powder from the mixture.

The step (2) preferably includes a step (B) of drying the mixture obtained in the step (1) to remove a liquid medium such as water. Examples of methods of the drying include the use of a shelf-type dryer, a vacuum dryer, a freeze dryer, a hot-air dryer, a drum dryer, or a spray dryer. Particularly preferred is spray drying. Spray drying is a technique of spraying a mixture of liquid and solid into gas for rapid drying to produce dry powder. This can provide a binder powder in the form of powder in which the fibrillatable resin and the thermoplastic polymer are uniformly mixed with each other. Spray drying is a commonly widely known technique and can be performed by a common manner using any known device. The step (B) can be performed by a common method using a commonly known device. For example, the drying temperature preferably falls within a range of 100° C. or higher and 250° C. or lower. Drying at 100° C. or higher is preferred to sufficiently remove the solvent, while drying at 250° C. or lower is preferred to more reduce energy consumption. The drying temperature is more preferably 110° C. or higher while more preferably 220° C. or lower. The amount of liquid fed may fall within a range of 0.1 L/h or more and 2 L/h or less, for example, although it depends on the production scale. The nozzle diameter for spraying a preparation solution may fall within a range of 0.5 mm or greater and 5 mm or smaller, for example, although it depends on the production scale.

The disclosure also relates to a method for producing a binder powder for an electrochemical device, the method including: a step (1) of preparing a mixture containing a fibrillatable resin, a thermoplastic polymer, and water; and a step (2) of producing a powder from the mixture.

The method for producing a binder powder for an electrochemical device of the disclosure can suitably produce the binder powder for an electrochemical device of the disclosure.

The fibrillatable resin and the thermoplastic polymer used may be the same as those described for the binder powder for an electrochemical device of the disclosure.

In the step (1), preferably, at least one selected from the group consisting of the fibrillatable resin and the thermoplastic polymer is mixed in the form of dispersion; more preferably, at least the thermoplastic polymer is mixed in the form of dispersion; still more preferably, both the fibrillatable resin and the thermoplastic polymer are mixed in the form of dispersion. The dispersion is preferably an aqueous dispersion.

The mixing as described above can reduce fibrillation of the fibrillatable resin and can easily provide a binder powder containing the non-fibrillated fibrillatable resin. Further, the fibrillatable resin and the thermoplastic polymer can be mixed uniformly.

In the step (1), a carbon conductive additive may be further added.

The dispersion may be an aqueous dispersion obtained by emulsion polymerization, or may be one obtained by preparing a powder by emulsion polymerization or suspension polymerization and dispersing the powder in an aqueous medium.

A dispersion of the fibrillatable resin is preferably an aqueous dispersion obtained by emulsion polymerization.

A dispersion of the thermoplastic polymer has an average primary particle size of preferably 50 μm or smaller, more preferably 20 μm or smaller, still more preferably 10 μm or smaller, further preferably 5 μm or smaller, particularly preferably 1 μm or smaller, while preferably 0.01 μm or greater, more preferably 0.05 μm or greater, still more preferably 0.10 μm or greater.

In the step (1), preferably, a dispersion containing the thermoplastic polymer having an average primary particle size of 50 μm or smaller is mixed with the fibrillatable resin and water.

The step (2) preferably includes a step (2-1) of coagulating a composition containing the fibrillatable resin and the thermoplastic polymer from the mixture to provide a coagulum; and a step (2-2) of heating the coagulum.

The coagulating in the step (2-1) can be performed by a known method. In the case of coagulating a polymer in an aqueous dispersion, the coagulation typically includes: diluting an aqueous dispersion obtained by producing, for example, a polymer latex by polymerization with water, optionally followed by pH adjustment to a neutral or alkaline value; and stirring the diluted aqueous dispersion in a container equipped with a stirrer. The average particle size can be adjusted by adjusting the temperature and concentration during the coagulation.

The temperature of the heating in the step (2-2) is preferably 10° C. or higher, more preferably 50° C. or higher, still more preferably 100° C. or higher, while preferably 300° C. or lower, more preferably 250° C. or lower, still more preferably 200° C. or lower.

The duration of the heating in the step (2-2) is preferably 10 minutes or longer, more preferably 30 minutes or longer, still more preferably 60 minutes or longer, while preferably 100 hours or shorter, more preferably 50 hours or shorter.

The binder powder for an electrochemical device of the disclosure is preferably intended to be used for a secondary battery.

The binder powder for an electrochemical device of the disclosure may further contain a carbon conductive additive.

Examples of the carbon conductive additive include graphite such as natural graphite and artificial graphite, carbon black such as acetylene black, Ketjen black, channel black, furnace black, lamp black, and thermal black, and amorphous carbon such as needle coke, carbon nanotube, fullerene, and VGCF.

The amount of the carbon conductive additive is preferably 0.01% by mass or more, more preferably 0.1% by mass or more, still more preferably 1% by mass or more, further preferably 2% by mass or more, while preferably 20% by mass or less, more preferably 15% by mass or less, still more preferably 10% by mass or less of the binder powder.

The disclosure also relates to a binder for an electrochemical device (hereinafter, also referred to as a binder (1) for an electrochemical device) containing a fibrillatable resin and an ethylene/tetrafluoroethylene copolymer.

The disclosure also relates to a binder for an electrochemical device (hereinafter, also referred to as a binder (2) for an electrochemical device) containing a fibrillatable resin and an elastomer having a glass transition temperature of 25° C. or lower.

The binders (1) and (2) for an electrochemical device are preferably powder.

The fibrillatable resin, the ethylene/tetrafluoroethylene copolymer, and the elastomer having a glass transition temperature of 25° C. or lower used may be the same as those described for the binder powder for an electrochemical device of the disclosure.

The ethylene/tetrafluoroethylene copolymer is preferably an ethylene/tetrafluoroethylene/hexafluoropropylene copolymer (EFEP).

The elastomer is preferably a fluoroelastomer.

The fluoroelastomer preferably contains a VdF unit and a unit of a monomer copolymerizable with the VdF.

The binders (1) and (2) for an electrochemical device of the disclosure contains the fibrillatable resin in an amount of preferably 40% by mass or more, more preferably 50% by mass or more, still more preferably 60% by mass or more, while preferably 99% by mass or less, more preferably 95% by mass or less, still more preferably 90% by mass or less of the binder.

The binder (1) for an electrochemical device of the disclosure contains the ethylene/tetrafluoroethylene copolymer in an amount of preferably 0.1% by mass or more, more preferably 0.5% by mass or more, still more preferably 1.0% by mass or more, further preferably 5.0% by mass or more, particularly preferably 10% by mass or more, while preferably 50% by mass or more, more preferably 40% by mass or less, still more preferably 30% by mass or less, further preferably 25% by mass or less of the binder.

The binder (1) for an electrochemical device of the disclosure contains the ethylene/tetrafluoroethylene copolymer in an amount of preferably 1% by mass or more, more preferably 5% by mass or more, still more preferably 10% by mass or more, while preferably 100% by mass or less, more preferably 75% by mass or less, still more preferably 50% by mass or less of the fibrillatable resin.

The binder (2) for an electrochemical device of the disclosure contains the elastomer having a glass transition temperature of 25° C. or lower in an amount of preferably 0.1% by mass or more, more preferably 0.5% by mass or more, still more preferably 1.0% by mass or more, 5.0% by mass or more, and 10% by mass or more, while preferably 40% by mass or less, more preferably 30% by mass or less, still more preferably 25% by mass or less of the binder.

The binder (2) for an electrochemical device of the disclosure contains the elastomer having a glass transition temperature of 25° C. or lower in an amount of preferably 1% by mass or more, more preferably 5% by mass or more, still more preferably 10% by mass or more, while preferably 67% by mass or less, more preferably 43% by mass or less, still more preferably 33% by mass or less of the fibrillatable resin.

The fibrillatable resin has a glass transition temperature of preferably 10° C. to 30° C.

The fibrillatable resin is preferably polytetrafluoroethylene.

The binders (1) and (2) for an electrochemical device contains the polytetrafluoroethylene in an amount of preferably 50% by mass or more.

The polytetrafluoroethylene has a peak temperature of preferably 333° C. to 347° C.

The binders (1) and (2) for an electrochemical device has a water content of preferably 1000 ppm by mass or less. The water content is more preferably 500 ppm by mass or less, still more preferably 200 ppm by mass or less, further preferably 100 ppm by mass or less, further more preferably 50 ppm by mass or less, particularly preferably 10 ppm by mass or less. The water content is determined by the following method.

The mass of the binder for an electrochemical device is weighed before and after heating at 150° C. for two hours, and the water content is calculated by the following formula. The sample is taken three times and this calculation is performed for each sample and the values are averaged. This average is taken as the water content.

Water content (ppm by mass)=[(mass (g) of binder for electrochemical device before heating)−(mass (g) of binder for electrochemical device after heating)]/(mass (g) of binder for electrochemical device before heating)×1000000

The binders (1) and (2) for an electrochemical device have an average primary particle size of preferably 10 to 500 nm. The average primary particle size is preferably 350 nm or smaller, more preferably 330 nm or smaller, still more preferably 320 nm or smaller, further preferably 300 nm or smaller, further more preferably 280 nm or smaller, particularly preferably 250 nm or smaller, while preferably 100 nm or greater, more preferably 150 nm or greater, still more preferably 170 nm or greater, particularly preferably 200 nm or greater.

The average primary particle size is determined by dynamic light scattering.

The binder for an electrochemical device is irradiated at 100 to 300 kGy and pulverized into fine particles using a pulverizer. The fine particles were combined with water and a nonionic surfactant and the components were sonicated such that the fine particles do not coagulate, whereby a dispersion is obtained. The average primary particle size can be determined by dynamic light scattering at 25° C. with 70 accumulations on an aqueous dispersion adjusted to have a solid concentration of about 1.0% by mass, with a solvent (water) having a refractive index of 1.3328 and a viscosity of 0.8878 mPa·s. The dynamic light scattering may be performed using ELSZ-1000S (available from Otsuka Electronics Co., Ltd.), for example.

The binders (1) and (2) for an electrochemical device have a maximum particle size of preferably smaller than 2000 μm. The maximum particle size is more preferably 1500 μm or smaller, still more preferably 1300 μm or smaller, further preferably 1000 μm or smaller. The maximum particle size is preferably 300 μm or greater.

The maximum particle size is defined as the particle size D90 that corresponds to 90% by weight cumulation in the particle size distribution determined in conformity with JIS Z8815.

For the binders (1) and (2) for an electrochemical device, the proportion of the number of fibrillatable resin particles having an aspect ratio of 30 or higher is preferably 20% or lower relative to the total number of the fibrillatable resin particles. The proportion of the number of fibrillatable resin particles having an aspect ratio of 30 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 30 or higher relative to the total number of the fibrillatable resin particles can be determined by the aforementioned method.

For the binders (1) and (2) for an electrochemical device, the proportion of the number of fibrillatable resin particles having an aspect ratio of 20 or higher is preferably 20% or lower relative to the total number of the fibrillatable resin particles. The proportion of the number of fibrillatable resin particles having an aspect ratio of 20 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 20 or higher relative to the total number of the fibrillatable resin particles can be determined by the aforementioned method.

For the binders (1) and (2) for an electrochemical device, the proportion of the number of fibrillatable resin particles having an aspect ratio of 10 or higher is preferably 20% or lower relative to the total number of the fibrillatable resin particles. The proportion of the number of fibrillatable resin particles having an aspect ratio of 10 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 10 or higher relative to the total number of the fibrillatable resin particles can be determined by the aforementioned method.

For the binders (1) and (2) for an electrochemical device, the proportion of the number of fibrillatable resin particles having an aspect ratio of 5 or higher is preferably 20% or lower relative to the total number of the fibrillatable resin particles. The proportion of the number of fibrillatable resin particles having an aspect ratio of 5 or higher relative to the total number of the fibrillatable resin particles is more preferably 15% or lower, still more preferably 10% or lower, further preferably 5% or lower, further more preferably 3% or lower, still further more preferably 2% or lower, particularly preferably 1% or lower, more particularly preferably 0.5% or lower.

The proportion of the number of fibrillatable resin particles having an aspect ratio of 5 or higher relative to the total number of the fibrillatable resin particles can be determined by the aforementioned method.

In the binders (1) and (2) for an electrochemical device of the disclosure, the non-fibrillated fibrillatable resin and the thermoplastic polymer are preferably mixed with each other, more preferably uniformly mixed with each other. Uniform mixing can be confirmed by the following average particle size, for example.

The binders (1) and (2) for an electrochemical device have an average particle size of preferably 1000 μm or smaller, more preferably 700 μm or smaller, while preferably 200 μm or greater, more preferably 300 μm or greater.

The average particle size can be determined in conformity with JIS 28815.

The binders (1) and (2) for an electrochemical device are preferably intended to be used for a secondary battery.

The binders (1) and (2) for an electrochemical device preferably further contains a carbon conductive additive.

Examples of the carbon conductive additive include graphite such as natural graphite and artificial graphite, carbon black such as acetylene black, Ketjen black, channel black, furnace black, lamp black, and thermal black, and amorphous carbon such as needle coke, carbon nanotube, fullerene, and VGCF.

The amount of the carbon conductive additive is preferably 0.01% by mass or more, more preferably 0.1% by mass or more, still more preferably 1% by mass or more, further preferably 2% by mass or more, while preferably 20% by mass or less, more preferably 15% by mass or less, still more preferably 10% by mass or less of the binder.

The binders (1) and (2) for an electrochemical device of the disclosure can be produced not only by the method for producing a binder powder for an electrochemical device of the disclosure but also by a known method.

The disclosure also relates to an electrode mixture obtainable by use of the aforementioned binder powder for an electrochemical device of the disclosure or an electrode mixture obtainable by use of the aforementioned binder (1) or (2) for an electrochemical device. The electrode mixture of the disclosure may be a positive electrode mixture or a negative electrode mixture, and is preferably a positive electrode mixture.

The electrode mixture commonly contains an electrode active material. The electrode mixture may further contain a conductive additive.

The features of the electrode mixture other than the binder may be those disclosed in WO 2022/050251, for example.

In the electrode mixture of the disclosure, the amount of the binder may be 0.1% by mass or more, preferably 0.2% by mass or more, more preferably 0.5% by mass or more, while may be 50% by mass or less, preferably 40% by mass or less, more preferably 30% by mass or less, still more preferably 10% by mass or less, particularly preferably 5% by mass or less, most preferably 3% by mass or less of the electrode mixture. Too low a proportion of the binder may cause a failure in sufficiently holding the electrode mixture active material and may cause poor mechanical strength of an electrode mixture sheet, resulting in poor battery performance such as cycle characteristics. Too high a proportion thereof may cause a reduced battery capacity and reduced conductivity. The binder powder for an electrochemical device of the disclosure as well as the binders (1) and (2) for an electrochemical device have excellent binding force. Thus, a small amount thereof can sufficiently hold the electrode active material.

The electrode mixture of the disclosure is preferably in the form of sheet.

The electrode mixture of the disclosure can suitably be used as an electrode mixture for a secondary battery. In particular, the electrode mixture of the disclosure is suitable for a lithium ion secondary battery. The electrode mixture of the disclosure, when used for a secondary battery, is commonly used in the form of sheet.

The electrode mixture sheet may be produced by any production method, and a specific example of the production method is described below.

The production method preferably includes:
(a) mixing a powdery component and a binder to provide an electrode mixture; and
(b) calendaring or extrusion-molding the electrode mixture, the mixing in the step (a) including:
   (a1) homogenizing the powdery component and the binder into powder; and
   (a2) mixing the material powder obtained in the step (a1) to provide the electrode mixture.

For example, PTFE has two transition temperatures at about 19° C. and about 30° C. At lower than 19° C., PTFE can be easily mixed while maintaining its shape. In contrast, at higher than 19° C., the PTFE particulate structure loosens and becomes more sensitive to mechanical shearing. At temperatures higher than 30° C., more significant fibrillation occurs.

Accordingly, the homogenizing in the step (a1) is preferably performed at 19° C. or lower, preferably at a temperature of 0° C. to 19° C.

In other words, such a step (a1) is preferably performed such that the materials are mixed and thereby homogenized while reducing fibrillation.

The mixing in the subsequent step (a2) is preferably performed at a temperature of 30° C. or higher to promote fibrillation.

The step (a2) is preferably performed at 30° C. to 150° C., more preferably 35° C. to 120° C., still more preferably 40° C. to 80° C.

In an embodiment, the calendaring or extrusion molding in the step (b) is performed at a temperature of 30° C. to 150° C., preferably 35° C. to 120° C., more preferably 40° C. to 100° C.

The mixing in the step (a) is preferably performed with shearing force applied.

Specific examples of mixing methods include mixing with the use of a W-shaped mixer, a V-shaped mixer, a drum mixer, a ribbon mixer, a conical screw mixer, a single screw kneader, a twin screw kneader, a mix muller, a stirring mixer, a planetary mixer, a Henschel mixer, or a rapid mixer.

For the mixing conditions, the number of rotations and the mixing duration are set as appropriate. For example, the number of rotations is suitably 15000 rpm or less, preferably 10 rpm or more, more preferably 1000 rpm or more, still more preferably 3000 rpm or more, while preferably 12000 rpm or less, more preferably 11000 rpm or less, still more preferably 10000 rpm or less. At the number of rotations below this range, mixing may take a long time, affecting the productivity. At the number of rotations above this range, fibrillation may occur excessively, resulting in an electrode mixture sheet having poor strength.

The (a1) is preferably performed at a weaker shearing force than that in the step (a2).

In the step (a2), the material composition preferably contains no liquid solvent, but a small amount of lubricant may be used. In other words, the powdery material mixture obtained in the step (a1) may be combined with a lubricant, whereby paste may be prepared.

Examples of the lubricant include, but are not limited to, water, ether compounds, alcohols, ionic liquids, carbonates, aliphatic hydrocarbons (e.g., low polar solvents such as heptane and xylene), isoparaffinic hydrocarbon compounds, and petroleum distillates (e.g., gasoline (C4-C10), naphtha (C4-C11), kerosene/paraffin (C10-C16), and mixtures of any of these).

The lubricant has a water content of preferably 1000 ppm or less.

A water content of 1000 ppm or less is preferred to reduce deterioration of the electrochemical device. The water content is more preferably 500 ppm or less.

The lubricant, when used, is particularly preferably a low polar solvent such as heptane or xylene or an ionic liquid.

The amount of the lubricant, when used, is 5.0 to 35.0 parts by weight, preferably 10.0 to 30.0 parts by weight, more preferably 15.0 to 25.0 parts by weight relative to the total weight of the composition fed to the step (a1).

The material composition preferably contains substantially no liquid solvent. In a conventional method for producing an electrode mixture, typically, a solvent containing a binder dissolved therein is used to prepare slurry containing an electrode mixture component in the form of powder dispersed therein, and applying and drying the slurry to produce an electrode mixture sheet. In this case, a solvent to dissolve a binder is used. Still, a solvent that can dissolve a binder resin commonly used in conventional cases is limited to specific solvents such as butyl butyrate. These solvents react with a solid electrolyte to deteriorate the solid electrolyte and may cause poor battery performance. In addition, low polar solvents such as heptane can dissolve very limited types of binder resin and have a low flash point, which may cause a difficulty in handling.

Not using a solvent but using a powdery binder containing less water in forming an electrode mixture sheet can provide a battery in which the solid electrolyte is less likely to be impaired. The above production method can provide an electrode mixture sheet containing a binder having a fine fibrous structure and can reduce a burden on the production process owing to elimination of slurry production.

The step (b) includes calendering or extrusion. The calendering and extrusion can be performed by known methods. Thereby, the material can be formed into the shape of an electrode mixture sheet.

The step (b) preferably includes (b1) forming the electrode mixture obtained in the step (a) into a bulky electrode mixture and (b2) calendering or extrusion-molding the bulky electrode mixture.

Forming into a bulky electrode mixture means forming the electrode mixture into a single mass.

Specific examples of methods of forming into a bulky shape include extrusion molding and press molding.

The term “bulky” does not specify the shape and means any state of single mass, including a rod shape, a sheet shape, a spherical shape, a cubic shape, and the like. The size of the mass is preferably such that the diameter or minimum side of the cross section is 10000 μm or greater, more preferably 20000 μm or greater.

A specific example of the calendering or extrusion molding in the step (b2) is a method of rolling the electrode mixture using a roller press or a calender roller.

The step (b) is preferably performed at 30° C. to 150° C. As described above, PTFE has a glass transition temperature around 30° C. and thus easily fibrillated at 30° C. or higher. Accordingly, the step (b) is preferably performed at such temperatures.

The calendering or extrusion molding applies a shearing force, which fibrillates the PTFE and gives the shape.

The step (b) may be preferably followed by a step (c) of applying a larger load on the resulting rolled sheet to form a thinner sheet-shaped product. Repeating the step (c) is also preferred. As described, better flexibility is achieved not by thinning the rolled sheet in one time but by rolling the sheet in steps.

The number of performing the step (c) is preferably twice or more and 10 times or less, more preferably three times or more and nine times or less.

A specific example of a rolling method is a method of rotating two or a plurality of rollers and passing the rolled sheet therebetween to provide a thinner sheet-shaped product.

In order to control the sheet strength, the step (b) or the step (c) is also preferably followed by a step (d) of coarsely crushing the rolled sheet, again forming the coarsely crushed product into a bulky product, and then rolling the bulky product into a sheet-shaped product. Repeating the step (d) is also preferred. The number of repeating the step (d) is once or more and 12 times or less, more preferably twice or more and 11 times or less.

Specific examples of coarsely crushing the rolled sheet and again forming the coarsely crushed product into a bulky product in the step (d) include a method of folding the rolled sheet, a method of forming the rolled sheet into a rod- or a thin sheet-shaped product, and a method of forming the rolled sheet into chips. The term “coarsely crushing” herein means changing the form of the rolled sheet obtained in the step (b) or step (c) into a different form so as to roll the product into a sheet-shaped product in the subsequent step, and encompasses simply folding the rolled sheet.

The step (d) may be followed by the step (c), or may be repeated.

In any of the steps (a), (b), (c), and (d), uniaxial stretching or biaxial stretching may be performed.

The sheet strength can also be adjusted in accordance with the degree of coarse crushing in the step (d).

In the step (b), (c), or (d), the rolling percentage is preferably 10% or higher, more preferably 20% or higher, while preferably 80% or lower, more preferably 65% or lower, still more preferably 50% or lower. A rolling percentage below this range may cause an increase in the number of rolling operations and a longer duration, affecting the productivity. A rolling percentage above the range may cause excessive fibrillation, resulting in an electrode mixture sheet having poor strength and poor flexibility.

The rolling percentage herein refers to the reduction in thickness of a sample after rolling processing relative to that before the processing. The sample before rolling may be a bulky material composition or may be a sheet-shaped material composition. The thickness of a sample refers to the thickness in the direction along which a load is applied during rolling.

The steps (c) to (d) are preferably performed at 30° C. or higher, more preferably 60° C. or higher, while preferably 150° C. or lower.

The electrode mixture sheet may be used as an electrode mixture sheet for a secondary battery and may be for either a negative electrode or a positive electrode. In particular, the electrode mixture sheet is suitable for a lithium ion secondary battery.

The disclosure also relates to an electrode obtainable by use of the aforementioned binder powder for an electrochemical device of the disclosure or an electrode obtainable by use of the binder (1) or (2) for an electrochemical device.

The electrode of the disclosure commonly contains an electrode active material and a current collector. The electrode of the disclosure is preferably intended to be used for a secondary battery.

The electrode of the disclosure may contain the aforementioned electrode mixture of the disclosure (preferably the electrode mixture sheet) and a current collector.

The electrode of the disclosure may be a positive electrode or may be a negative electrode, and is preferably a positive electrode.

The features of the electrode other than the binder may be those disclosed in WO 2022/050251, for example.

The disclosure also provides a secondary battery including the aforementioned electrode of the disclosure.

The secondary battery of the disclosure may be a secondary battery obtainable by use of an electrolyte solution or may be a solid-state secondary battery.

The secondary battery obtainable by use of an electrolyte solution may be obtained by use of components used for a known secondary battery, such as an electrolyte solution and a separator.

The features of the secondary battery obtainable by use of an electrolyte solution other than the binder may be those disclosed in WO 2022/050251, for example.

The solid-state secondary battery is preferably an all-solid-state secondary battery. The solid-state secondary battery is preferably a lithium ion battery or is preferably a sulfide-based all-solid-state secondary battery.

The solid-state secondary battery preferably includes a positive electrode, a negative electrode, and a solid electrolyte layer between the positive electrode and the negative electrode.

The features of the solid-state secondary battery other than the binder may be those disclosed in WO 2022/050252, for example.

In a first aspect, a composite binder material is provided, the composite binder material including polytetrafluoroethylene (PTFE); a low-melting point thermoplastic; and a conductive additive.

In a second aspect, a method of making a composite binder material is provided, the method including: providing an emulsion of PTFE; mixing a low-melting point thermoplastic and a particulate conductive additive into the emulsion of PTFE to form a first mixture; and coagulating the first mixture to produce a coagulum including the composite binder material.

In a third aspect, the composite binder that is the product of the process of the second aspect is provided.

In a fourth aspect, an electrode is provided, the electrode including the composite binder material of the first or third aspects.

In a fifth aspect, an energy storage device is provided, the energy storage device including the electrode of the fourth aspect.

The disclosure relates to a binder powder for an electrochemical device, containing:
a non-fibrillated fibrillatable resin; and
a thermoplastic polymer.

The thermoplastic polymer is preferably a thermoplastic resin.

The thermoplastic resin preferably has a melting point of 100° C. to 310° C.

The thermoplastic resin is preferably a fluoropolymer.

The thermoplastic resin preferably has a melt flow rate of 0.01 to 500 g/10 min.

The thermoplastic polymer is preferably an elastomer having a glass transition temperature of 25° C. or lower.

The elastomer is preferably a fluoroelastomer.

The fluoroelastomer preferably contains a unit of vinylidene fluoride and a unit of a monomer copolymerizable with the vinylidene fluoride.

The fibrillatable resin preferably has a glass transition temperature of 10° C. to 30° C.

The fibrillatable resin is preferably polytetrafluoroethylene.

The polytetrafluoroethylene is preferably contained in an amount of 50% by mass or more.

The polytetrafluoroethylene preferably has a peak temperature of 333° C. to 347° C.

The binder powder preferably has a water content of 1000 ppm by mass or less.

The binder powder preferably has an average primary particle size of 10 to 500 nm.

Preferably, the fibrillatable resin is in the form of particles, and
a proportion of the number of fibrillatable resin particles having an aspect ratio of 30 or higher is 20% or lower relative to the total number of the fibrillatable resin particles.

The binder powder preferably has an average particle size of 1000 μm or smaller.

The binder powder is preferably intended to be used for a secondary battery.

The binder powder preferably further contains a carbon conductive additive.

The disclosure also relates to an electrode mixture obtainable by use of the binder powder for an electrochemical device.

Producing the electrode mixture preferably includes use of an active substance.

The electrode mixture is preferably a positive electrode mixture.

The disclosure also relates to an electrode for a secondary battery, the electrode being obtainable by use of the binder powder for an electrochemical device.

The disclosure also relates to a secondary battery including the electrode for a secondary battery.

The disclosure also relates to a method for producing a binder powder for an electrochemical device, the method including:
a step (1) of preparing a mixture containing a fibrillatable resin, a thermoplastic polymer, and water; and
a step (2) of producing a powder from the mixture.

The step (2) preferably includes:
a step (2-1) of coagulating a composition containing the fibrillatable resin and the thermoplastic polymer from the mixture to provide a coagulum; and
a step (2-2) of heating the coagulum.

In the step (1), a dispersion containing the thermoplastic polymer having an average primary particle size of 50 μm or smaller is preferably mixed with the fibrillatable resin and water.

The disclosure also relates to a binder for an electrochemical device, the binder containing:
a fibrillatable resin; and
an ethylene/tetrafluoroethylene copolymer.

The disclosure also relates to a binder for an electrochemical device, the binder containing:
a fibrillatable resin; and
an elastomer having a glass transition temperature of 25° C. or lower.

The binder for an electrochemical device is preferably powder.

The elastomer is preferably a fluoroelastomer.

The fluoroelastomer preferably contains a unit of vinylidene fluoride and a unit of a monomer copolymerizable with the vinylidene fluoride.

The fibrillatable resin preferably has a glass transition temperature of 10° C. to 30° C.

The fibrillatable resin is preferably polytetrafluoroethylene.

The polytetrafluoroethylene is preferably contained in an amount of 50% by mass or more.

The polytetrafluoroethylene preferably has a peak temperature of 333° C. to 347° C.

The binder preferably has a water content of 1000 ppm by mass or less.

The binder preferably has an average primary particle size of 10 to 500 nm.

The binder is preferably intended to be used for a secondary battery.

The binder preferably further contains a carbon conductive additive.

The disclosure also relates to an electrode mixture obtainable by use of the binder for an electrochemical device.

The electrode mixture preferably further contains an active material.

The electrode mixture is preferably a positive electrode mixture.

The disclosure also relates to an electrode for a secondary battery, the electrode being obtainable by use of the binder for an electrochemical device.

The disclosure also relates to a secondary battery including the electrode for a secondary battery.

### EXAMPLES

The disclosure is described in more detail below with reference to examples, but the disclosure is not limited to these examples.

Composite binder materials were produced in accordance with the present disclosure. The following samples of composite binder materials were prepared and tested.
Sample 1: PTFE with integrated conductive carbon and varying amounts of EFEP (5% w/w, 7.5% w/w, 10% w/w, and 20% w/w)
Sample 2: high-molecular weight PTFE with integrated conductive carbon and varying amounts of EFEP (5% w/w, 7.5% w/w, 10% w/w, and 20% w/w)
Sample 3: modified PTFE with integrated conductive carbon and varying amounts of EFEP (10% w/w and 20% w/w)

### Preparation Method

Composite binder materials were prepared according to the following method. PTFE emulsion was obtained from the aqueous polymerization of tetrafluoroethylene in the presence of an emulsifier, paraffin wax, and an initiator. The wax was first separated by decanting the emulsion from the lighter wax phase. After separation from the wax phase, the coagulation process of the PTFE emulsion began by initiating mechanical agitation. The rate of agitation was set to be enough to generate a vortex for pulling added material into the PTFE emulsion, but not too high as to apply excess shear to the emulsion. The conductive additive and low melting point thermoplastic (EFEP) were added to the PTFE emulsion at the onset of the observed vortex. Coagulation of secondary particles, or the separation of PTFE from the aqueous phase, occurred when sufficient energy was applied to the suspension through mechanical agitation. Distinct secondary particles of PTFE containing the integrated conductive additive and EFEP were observed upon completion. The coagulated material was then decanted from the remaining liquid and dried at an elevated temperature.

### Results

### Imaging of Composite Binder Materials

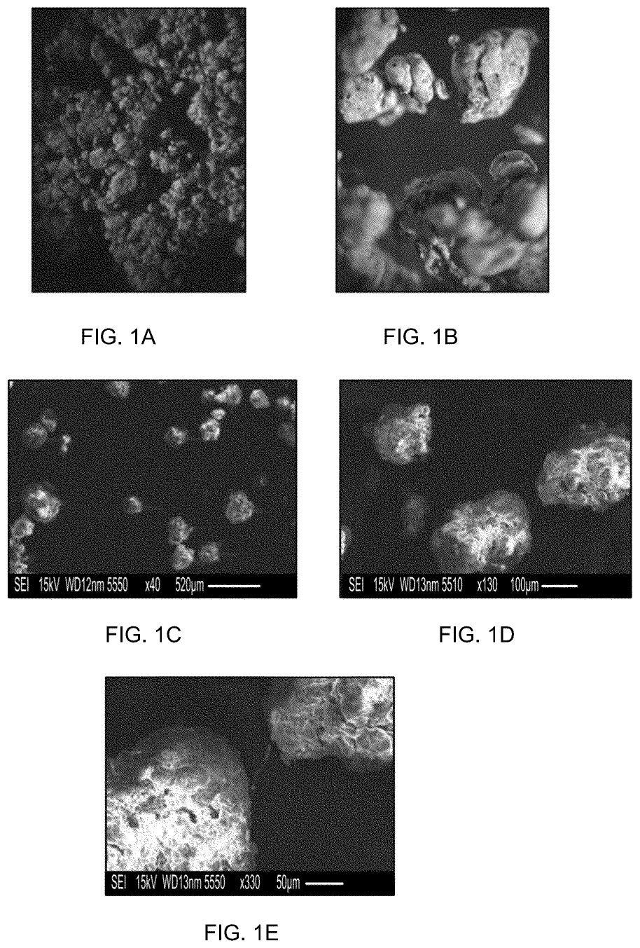

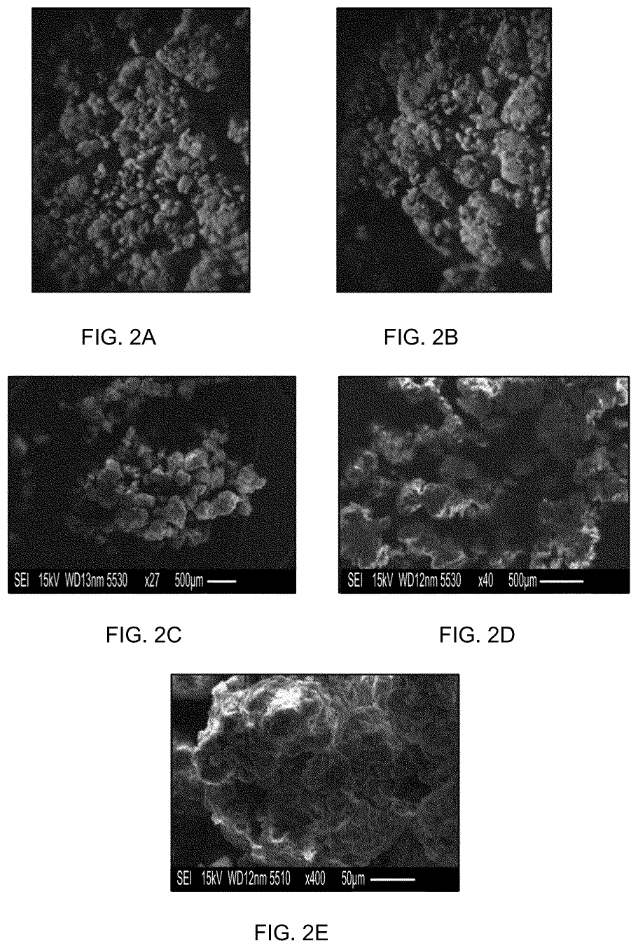

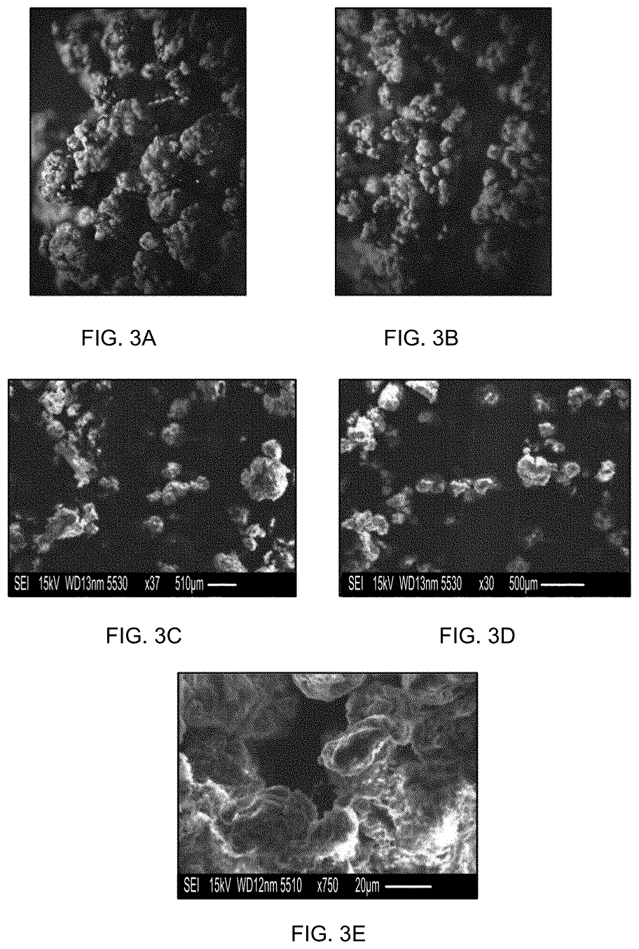

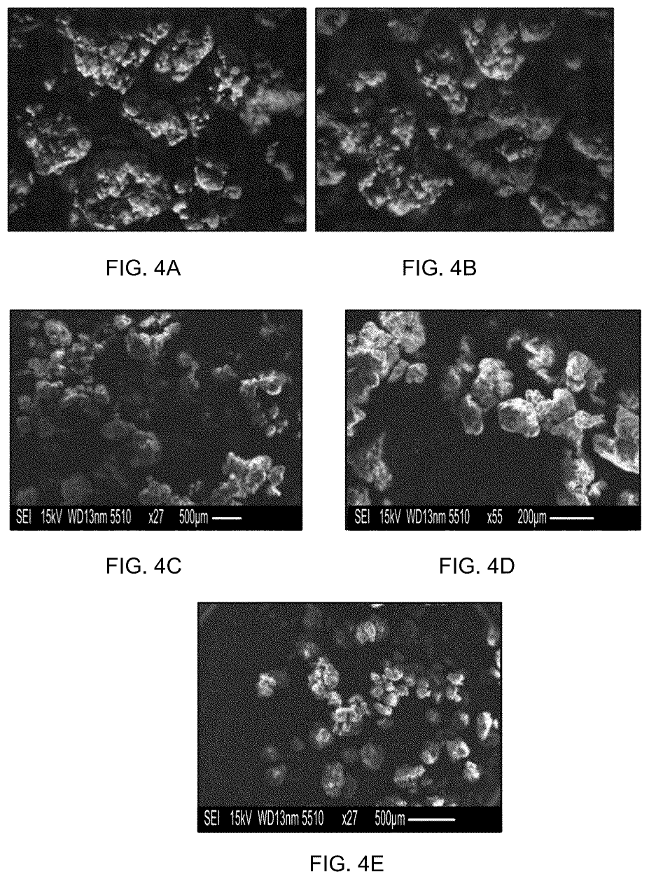

FIGS. 1A-1E show images of the PTFE particles integrated with conductive carbon and 5% w/w of EFEP. FIGS. 2A-2E show images of the PTFE particles integrated with conductive carbon and 7.5% w/w of EFEP. FIGS. 3A-3E show images of the PTFE particles integrated with conductive carbon and 10% w/w of EFEP. FIGS. 4A-4E show images of the PTFE particles integrated with conductive carbon and 20% w/w of EFEP. As shown in FIGS. 1A-1E, 2A-2E, 3A-3E, and 4A-4E, the composite binder materials have the appearance of a fluffy grey to black powder. The conductive carbon is integrated within the PTFE so that little to no conductive carbon is deposited on containers or hands when handling.

### Adhesion Testing

Samples 1, 2, and 3 of the composite binder materials were tested for adhesion strength using a composite binder peel test. The purpose of the peel test is to measure the force required to pull metal strips from a composite binder. Any reference to an adhesion peel test in this disclosure or the claims should be assumed to refer to an adhesion peel test performed as described here. Aluminum was chosen as the metal because it serves as the current collector for cathodes in lithium ion batteries. The peel test was performed in accordance with the following procedure:
1. “Cathode grade” aluminum foil was cut into strips measuring 2 cm×25 cm using a hand press. There were no folds or creases in the cut strips.
2. The composite binder was evenly distributed onto one strip, leaving approximately 2 cm of the end of the strip uncoated. The composite binder was placed onto the strip with a “draw down blade.”
3. The second strip was placed on top of the coated strip and slight pressure was applied. Both strips (with the cathode mixture between them) were placed in a heat press.
4. The cathode was allowed to cool for a minimum of 1 hour to a temperature of 22+3° C.
5. Using an Instron Mechanical Tester, the portions of the strips with no cathode mixture were mounted in the machine clamps.
6. The Instron Mechanical Tester was set to pull at 10 in/min (25 cm/min) and the load was measured on the pressure transducer. The measurement length was at least 2 in (5 cm). The reported load is the average load over the measured distance.

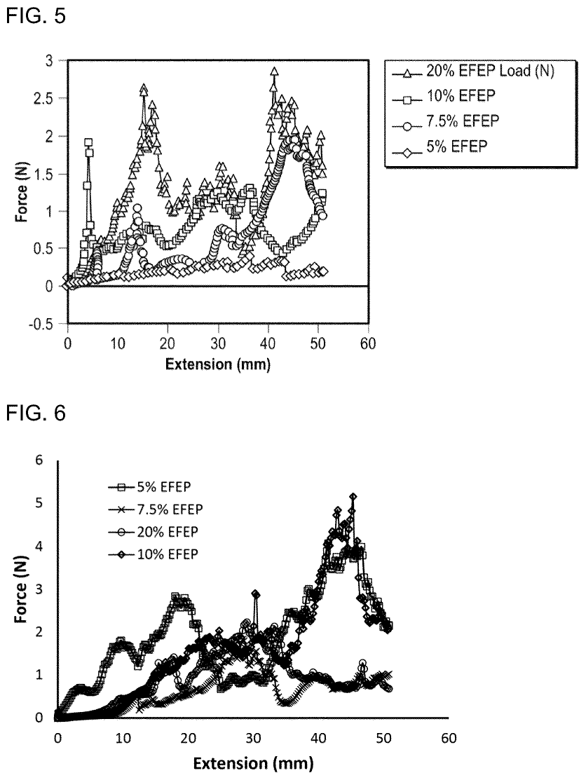

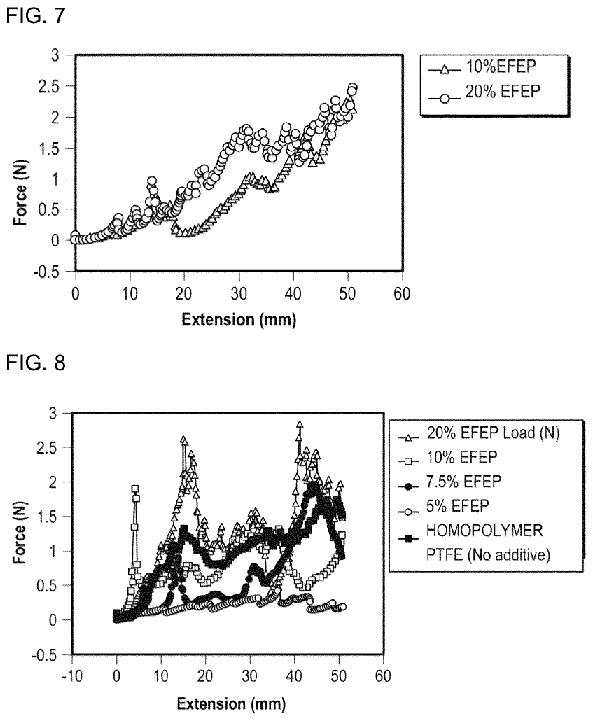

FIG. 5 shows the adhesion strength of PTFE particles integrated with conductive carbon and varying amounts of EFEP (5% w/w, 7.5% w/w, 10% w/w, and 20% w/w). FIG. 6 shows the adhesion strength of high-molecular weight PTFE particles integrated with conductive carbon and varying amounts of EFEP (5% w/w, 7.5% w/w, 10% w/w, and 20% w/w). FIG. 7 shows the adhesion strength of modified PTFE particles integrated with conductive carbon and varying amounts of EFEP (10% w/w and 20% w/w). FIG. 8 shows the adhesion strength of PTFE particles with no additives compared with PTFE particles integrated with conductive carbon and varying amounts of EFEP (5% w/w, 7.5% w/w, 10% w/w, and 20% w/w).

As shown in FIGS. 5-8, the composite binder materials produced in accordance with the present disclosure exhibited adhesion strength of >1 N mm with high-purity aluminum, when adhesion tested using a 25 mm width film with high-purity aluminum on both sides.

### FTIR—Chemical Functional Groups

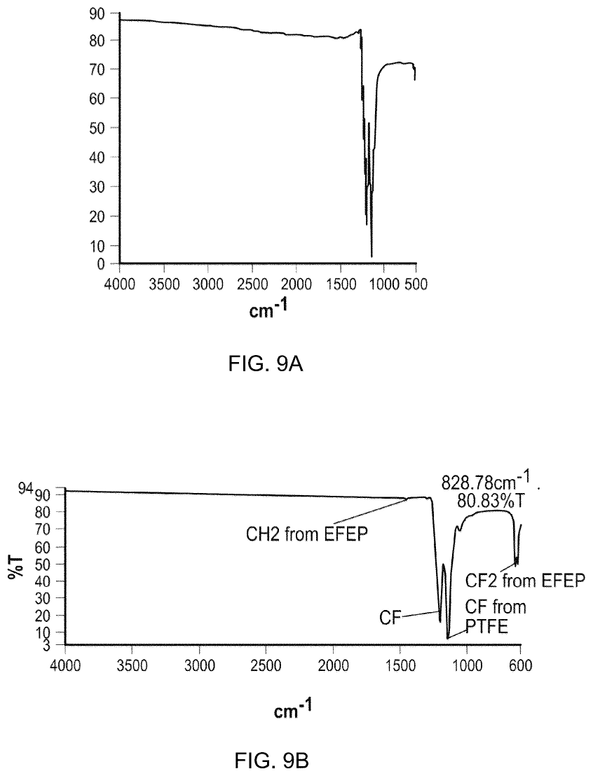

The composite binder material was placed on an FTIR-ATR instrument. FIG. 9A shows the ATR-FTIR spectra of PTFE particles integrated with conductive carbon, while FIG. 9B shows the ATR-FTIR spectra of PTFE particles integrated with conductive carbon and EFEP. As demonstrated by FIGS. 9A and 9B, functional group identification suggests the presence of both PTFE and EFEP in the composite binder material.

### Thermogravimetric Analysis (TGA)—Weight Loss Testing

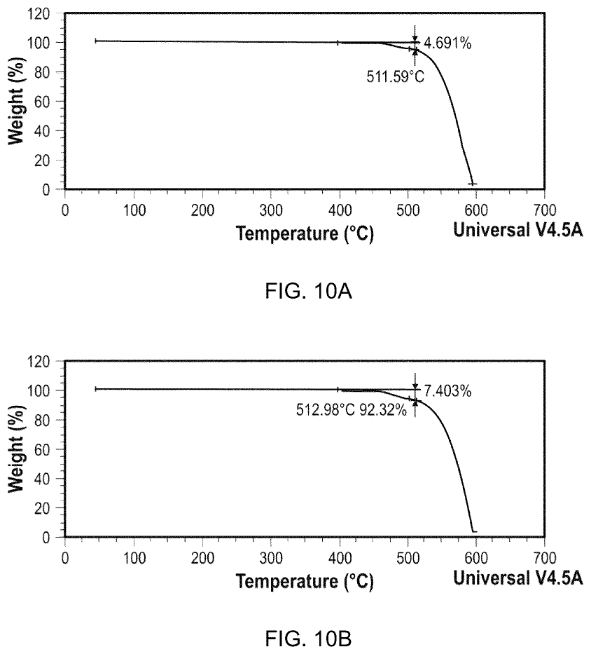

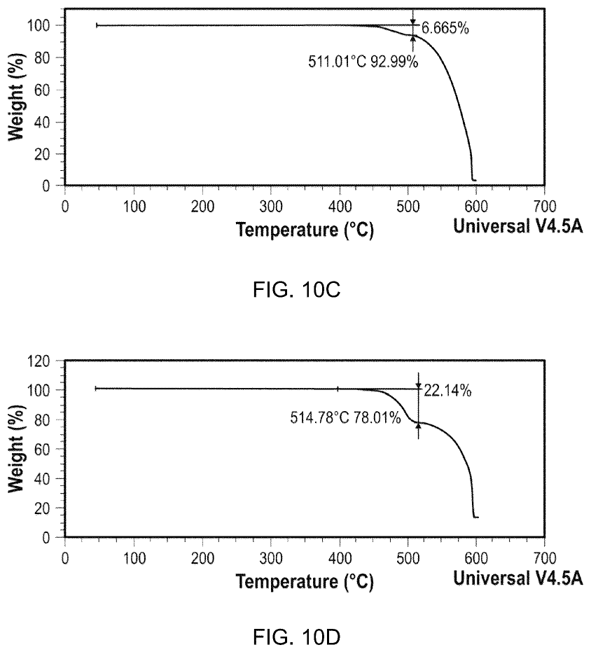

A TGA test was performed on Sample 1 (PTFE with integrated conductive carbon and varying amounts of EFEP (5% w/w, 7.5% w/w, 10% w/w, and 20% w/w)). FIGS. 10A-10D show the weight loss (%) with respect to the temperature increase for each of the binder materials.

The foregoing description illustrates and describes the processes, manufactures, compositions of matter, and other teachings of the present disclosure. Additionally, the disclosure shows and describes only certain embodiments of the processes, manufactures, compositions of matter, and other teachings disclosed, but, as mentioned above, it is to be understood that the teachings of the present disclosure are capable of use in various other combinations, modifications, and environments and are capable of changes or modifications within the scope of the teachings as expressed herein, commensurate with the skill and/or knowledge of a person having ordinary skill in the relevant art. The embodiments described hereinabove are further intended to explain certain best modes known of practicing the processes, manufactures, compositions of matter, and other teachings of the present disclosure and to enable others skilled in the art to utilize the teachings of the present disclosure in such, or other, embodiments and with the various modifications required by the particular applications or uses. Accordingly, the processes, manufactures, compositions of matter, and other teachings of the present disclosure are not intended to limit the exact embodiments and examples disclosed herein. Any section headings herein are provided only for consistency with the suggestions of 37 C.F.R. § 1.77 or otherwise to provide organizational queues. These headings shall not limit or characterize the invention(s) set forth herein.

### Average Primary Particle Size

The average primary particle size was determined by dynamic light scattering at 25° C. with 70 accumulations on a fluoropolymer aqueous dispersion adjusted to have a fluoropolymer solid concentration of about 1.0% by mass using ELSZ-1000S (available from Otsuka Electronics Co., Ltd.). The solvent (water) had a refractive index of 1.3328 and a viscosity of 0.8878 mPa·s.

### Solid Concentration (P)

About 1 g (X) of a sample was placed on a 5-cm-diameter aluminum cup and dried at 150° C. for one hour. Based on the resulting heating residue (Z), the solid concentration was determined by the formula: P=Z/X×100(%).

### Composition of Fluoropolymer

The composition of a fluoropolymer was determined by ¹H-NMR analysis and ¹⁹F-NMR analysis.

### Standard Specific Gravity (SSG)

The SSG was determined by the water displacement method in conformity with ASTM D792 using a sample formed in conformity with ASTM D4895.

### Peak Temperature of Fibrillatable Resin

The peak temperature was defined as the temperature corresponding to the maximum value on a heat-of-fusion curve drawn by increasing the temperature at a rate of 10° C./min using a differential scanning calorimeter (DSC) for a PTFE that had never been heated up to 300° C. or higher.

### Melting Point of Thermoplastic Polymer

The melting point was defined as the temperature corresponding to the maximum value on a heat-of-fusion curve drawn by increasing the temperature as a second run at a rate of 10° C./min using a differential scanning calorimeter (DSC).

### Measurement of Glass Transition Temperature (Tg)

The glass transition temperature was defined as the temperature corresponding to the maximum value on a heat-of-fusion curve drawn by cooling a sample down to −50° C. and then increasing the temperature up to 50° C. at a rate of 10° C./min using a differential scanning calorimeter (available from Seiko Instruments & Electronics Ltd.).

### MFR of Thermoplastic Polymer

The melt flow rate was determined as the weight (g) of a polymer that flowed out of a nozzle having an inner diameter of 2 mm and a length of 8 mm per unit time (10 minutes) at a predetermined temperature and under a predetermined load using a melt indexer (available from Toyo Seiki Seisaku-sho, Ltd.) in conformity with ASTM D1238.

### Mooney Viscosity (ML1+10 (121° C., 140° C.)) of Fluoroelastomer

The Mooney viscosities were determined in conformity with ASTM D1646-15 and JIS K6300-1:2013.

Measurement apparatus: model MV2000E available from Alpha Technologies

Number of rotations of rotor: 2 rpm

Measurement temperature: 121° C., 140° C.

Measurement duration: pre-heating for one minute, immediately followed by rotation of a rotor for 10 minutes, then determination of the value

### Heat of Fusion of Fluoroelastomer

The temperature of 10 mg of a sample was increased at 20° C./min using a differential scanning calorimeter (X-DSC823e, available from High-Tech Science Corp.), whereby a DSC curve was drawn. The heat of fusion was then calculated from the intensity of the fusion peak (AH) appearing on the DSC curve.

### Glass Transition Temperature (Tg) of Fluoroelastomer

The temperature of 10 mg of a sample was increased at 20° C./min using a differential scanning calorimeter (X-DSC823e, available from High-Tech Science Corp.), whereby a DSC curve was drawn. The glass transition temperature was defined as the temperature indicating the intersection of the extension of the base line before and after the secondary transition of the DSC curve and the tangent at the inflection point of the DSC curve.

### Ratio of Contained Polar Groups of Fluoroelastomer

End group analysis was performed by NMR in accordance with the aforementioned method, whereby the ratio ([—CH₂OH]+[—COOH])/([—CH₃]+[—CF₂H]+[—CH₂OH]+[—CH₂I]+[—OC(O)RH]+[—COOH]) was calculated.

### Weight Average Molecular Weight of Fluoroelastomer

The weight average molecular weight was determined by gel permeation chromatography (GPC). AS-8010 and CO-8020, each available from Tosoh Corp., columns (three GMHHR-H columns connected in series), and RID-10A available from Shimadzu Corp. were used, with dimethylformamide (DMF) as a solvent passed through the system at a flow rate of 1.0 ml/min to obtain data (reference: polystyrene). Based on the data, the weight average molecular weight was calculated.

### Water Content

The mass of the powder mixture for an electrochemical device was weighed before and after heating at 150° C. for two hours, and the water content was calculated by the following formula. The sample was taken three times and this calculation was performed for each sample, and the values were then averaged. This average was taken as the water content.

Water content (ppm by mass)=[(mass (g) of binder powder for electrochemical device before heating)−(mass (g) of binder powder for electrochemical device after heating)/(mass (g) of binder powder for electrochemical device before heating)×1000000

### Average Particle Size

The average particle size was defined as the particle size D50 that corresponds to 50% by weight cumulation in the particle size distribution determined in conformity with JIS Z8815.

### Maximum Particle Size

The maximum particle size was defined as the particle size D90 that corresponds to 90% by weight cumulation in the particle size distribution determined in conformity with JIS Z8815.

### Average Particle Size of PVDF Powder

A laser diffraction particle size distribution analyzer (LS13 320) available from Beckman Coulter Inc. was used for measurement in a dry mode at a vacuum pressure of 20 mH₂O. Based on the resulting particle size distribution (based on volume), the average particle size was determined. The average particle size was defined as being equal to the particle size corresponding to 50% of the cumulative particle size distribution.

### Synthesis Example

A white solid A was obtained by the method disclosed in Synthesis Example 1 of WO 2021/045228.

### Preparation Example 1 (PTFE-1 Aqueous Dispersion)

A 6-L reaction container equipped with a stirring blade and a temperature-controlling jacket was charged with 3480 g of deionized water, 100 g of paraffin wax, and 5.25 g of the white solid A serving as a fluorine-containing surfactant. The inside of the reaction container was purged with nitrogen gas to remove oxygen while the system was warmed to 70° C. Tetrafluoroethylene (TFE) was injected to control the pressure inside the system to 0.78 MPaG and the temperature inside the container was maintained at 70° C. under stirring. Next, 15.0 mg of ammonium persulfate was dissolved in 20 g of water and the resulting aqueous solution was injected into the system, whereby a polymerization reaction was initiated. The reaction pressure dropped as the polymerization reaction proceeded. TFE was thus added so that the temperature inside the container was maintained at 70° C. and the reaction pressure was maintained at 0.78 MPa.

At the timing when 400 g of TFE was fed from the start of the polymerization, an aqueous solution prepared by dissolving 18.0 mg of hydroquinone serving as a radical scavenger in 20 g of water was injected into the system. The polymerization was further continued. At the timing when the amount of TFE fed reached 1200 g from the start of the polymerization, stirring and feeding of TFE were stopped. Immediately thereafter, the gas inside the reaction container was released for normal pressure and the polymerization reaction was finished. The resulting aqueous dispersion was taken and cooled, and the paraffin wax was separated, whereby a PTFE aqueous dispersion was obtained. The resulting PTFE aqueous dispersion had a solid concentration of 25.3% by mass and an average primary particle size of 310 nm. The peak temperature was 344° C.

### Preparation Example 2 (PTFE-1 Powder)

The PTFE aqueous dispersion obtained in Preparation Example 1 was diluted to a solid concentration of 13% by mass and the PTFE was coagulated under stirring in a container. Water was then filtered out, whereby a PTFE wet powder was obtained.

The resulting wet powder was placed on a stainless steel mesh tray and the mesh tray was heated in a hot-air-circulating electric furnace at 130° C. After 20 hours, the mesh tray was taken and air-cooled, whereby a PTFE powder was obtained.

The resulting PTFE powder had a SSG of 2.159, a peak temperature of 344° C., a glass transition temperature of 22° C., and an average particle size of 540 μm.

### Preparation Example 3 (PTFE-2 Aqueous Dispersion)

A 6-L reaction container equipped with a stirring blade and a temperature-controlling jacket was charged with 3600 g of deionized water, 180 g of paraffin wax, 5.4 g of the white solid A serving as a fluorine-containing surfactant, and 0.025 g of oxalic acid. The inside of the reaction container was purged with nitrogen gas to remove oxygen while the system was warmed to 70° C. The temperature inside the container was maintained at 70° C. under stirring and TFE gas was then introduced into the container up to a pressure of 2.7 MPaG.

Under stirring of the contents, deionized water containing 3.5 mg of potassium permanganate dissolved therein was continually added to the system at a constant rate. In addition, TFE was continually fed to maintain the pressure inside the reaction container at 2.7 MPaG. At the timing when 184 g of TFE was consumed, 5.3 g of the white solid A was added to the system. At the timing when 900 g of TFE was consumed, the whole deionized water containing 3.5 mg of potassium permanganate dissolved therein was completely added to the system. At the timing when 1540 g of TFE was consumed, stirring and feeding of TFE were stopped. The TFE inside the polymerization container was purged, whereby the polymerization reaction was finished. The aqueous dispersion was taken and cooled, and the paraffin wax was separated, whereby a PTFE aqueous dispersion was obtained. The resulting PTFE aqueous dispersion had a solid concentration of 29.7% by mass and an average primary particle size of 296 nm.

The resulting PTFE aqueous dispersion was diluted to a solid concentration of 13% by mass and the PTFE was coagulated under stirring in a container. Water was then filtered out and the residue was dried, whereby a PTFE powder was obtained.

The resulting PTFE powder had a SSG of 2.152, a peak temperature of 345° C., and a glass transition temperature of 22° C.

### Preparation Example 4 (PVDF Aqueous Dispersion)

With reference to Example 1 of JP 2014-141673 A, a PVDF aqueous dispersion was obtained. Specifically, A 3.0-L stainless steel autoclave was charged with 1700 g of pure water, 0.85 g of a surfactant H—(CF₂CF₂)₃—CH₂—O—CO—CH₂CH(—SO₃Na)—CO—O—CH₂—(CF₂CF₂)₃—H (surface tension 22 mN/m), and 17 g of paraffin wax and purged with nitrogen. Then, 150 g of vinylidene fluoride (VdF) was fed and the temperature inside the container was increased up to 115° C. Thereto were added 0.51 g of acetone and 5.6 g of di-t-butyl peroxide under stirring, whereby a reaction was initiated. Then, 427 g of vinylidene fluoride was fed over nine hours to maintain the pressure inside the container at 4.0 MPaG, with 1.45 g of H—(CF₂CF₂)₃—CH₂—O—CO—CH₂CH(—SO₃Na)—CO—O—CH₂—(CF₂CF₂)₃—H fed during the feeding of VdF. Thereby, 2112.45 g of a stable PVDF aqueous dispersion (solid concentration 20.6% by mass) was obtained.

The resulting PVDF had a melting point of 160.8° C. and an average primary particle size of 171 nm.

### Preparation Example 5 (PVDF Powder)

The PVDF aqueous dispersion obtained in Preparation Example 4 was coagulated, dried, and pulverized, whereby a PVDF powder was obtained.

The resulting PVDF had a MFR of 1.05 g/10 min at 230° C. and a load of 98 N (10 kg) and an average particle size of 1.1 μm.

Preparation Example 6 (VdF/TFE copolymer (fluoropolymer A) powder)

White powder of a fluoropolymer was obtained in accordance with Preparation Example 8 of WO 2013/176093.

The resulting fluoropolymer had a composition of VdF/TFE=82.9/17.1 (mol %), a melting point of 131° C., a MFR of 1 g/10 min at 297° C. and a load of 212 N (21.6 kg), a weight average molecular weight of 1210000, and an average particle size of 400 μm.

### Preparation Example 7 (Et/TFE/HFP Copolymer (EFEP) Powder)

A fluoropolymer powder was obtained in accordance with Synthesis Example 7 of JP 2006-306105 A. Specifically, an autoclave was charged with 380 L of deionized water and purged with nitrogen. The system was supplied with 75 kg of 1-fluoro-1,1-dichloroethane, 155 kg of hexafluoropropylene, and 0.5 kg of perfluoro(1,1,5-trihydro-1-pentene) and maintained at an internal temperature of 35° C. and a stirring rate of 200 rpm. Tetrafluoroethylene was injected up to 0.7 MPaG and ethylene was then injected up to 1.0 MPaG. Then, 2.4 kg of di-n-propyl peroxydicarbonate was fed to the system, whereby polymerization was initiated. The pressure inside the system dropped as the polymerization proceeded. Thus, a gas mixture of tetrafluoroethylene (TFE)/ethylene (Et)/hexafluoropropylene (HFP)=40.5/44.5/15.0 mol % was continually fed to maintain the pressure inside the system at 1.0 MPaG. Also, 1.5 kg in total of perfluoro(1,1,5-trihydro-1-pentene) (HF-Pa) was continually fed to the system and stirring was continued for 20 hours. The pressure was then released to the atmospheric pressure and the reaction product was washed with water and dried. Thereby, 200 kg of a powder was obtained.

The resulting fluoropolymer had a composition of TFE/Et/HFP/HF-Pa=40.8/44.8/13.9/0.5 (mol %). The resulting fluoropolymer had a melting point of 162.5° C. and a MFR of 2.6 g/10 min at 230° C. and a load of 49 N (5 kg).

### Production Example 8 (VDF/TFP Elastomer (Elastomer A))

A 6-L stainless steel autoclave was charged with 4000 ml of pure water and purged with nitrogen. The system was supplied with 0.09 ml of 2-methylbutane in a vacuum and slightly pressurized with vinylidene fluoride (VdF). The temperature was controlled to 80° C. under stirring at 600 rpm. VdF was injected up to 1.62 MPaG, followed by injection of a liquid monomer mixture containing VdF and 2,3,3,3-tetrafluoropropene in a mole ratio of 76.5/23.5 up to 2.001 MPaG. A solution of 0.952 g of ammonium persulfate in 5 ml of pure water was injected with nitrogen, whereby polymerization was initiated. Continuous monomers were fed to maintain the pressure at 2.0 MPaG. After 3.6 hours had passed from the start of the polymerization and when 1.0 kg of the continuous monomers were fed, stirring was stopped. The gas inside the autoclave was released and the system was cooled, and then 5.0 kg of a dispersion was collected. The dispersion had a solid content of 20.27% by weight.

The resulting elastomer contained VdF and 2,3,3,3-tetrafluoropropene in a mole ratio of 77.2/22.8. The resulting elastomer had a Mooney viscosity (ML1+10 (140° C.)) of 135, a weight average molecular weight of 1600000, a Tg of −12° C. by DSC, and a ratio of contained polar groups of 0.03. No heat of fusion was observed in the second run.

### Preparation Example 9 (VDF/HFP Elastomer (Elastomer B))

A 3-L stainless steel autoclave was charged with 1650 ml of pure water and purged with nitrogen. The system was slightly pressurized with hexafluoropropylene (HFP) and the temperature was controlled to 80° C. under stirring at 380 rpm. HFP was injected up to 0.23 MPaG, followed by injection of a liquid monomer mixture containing vinylidene fluoride (VdF) and HFP in a mole ratio of 78.2/21.8 up to 1.472 MPaG. Then, 0.097 mL of 2-methylbutane was injected with nitrogen and a solution of 36.4 g of ammonium persulfate in 80 ml of pure water was injected with nitrogen, whereby polymerization was initiated. When the pressure dropped to 1.44 MPaG, continuous monomers were fed so that the pressure was increased up to and maintained at 1.50 MPaG. After about 9.3 hours had passed from the start of the polymerization and when 607 g of the continuous monomers were fed, stirring was stopped. The gas inside the autoclave was released and the system was cooled, and then 2299 g of a dispersion was collected. The dispersion had a solid content of 26.9% by weight.

The resulting elastomer contained VdF and HFP in a mole ratio of 77.9/22.1. The resulting elastomer had a Mooney viscosity (ML1+10 (140° C.)) of 77, a weight average molecular weight of 850000, a Tg of −18° C. by DSC, and a ratio of contained polar groups of 0.05. No heat of fusion was observed in the second run.

### Production Example 1

A container was charged with 692 g of the PTFE-1 aqueous dispersion obtained in Preparation Example 1 and 850 g of the PVDF aqueous dispersion obtained in Preparation Example 4. The PTFE/PVDF mixture was co-coagulated under rapid stirring and water is then filtered out, whereby a wet powder was obtained.

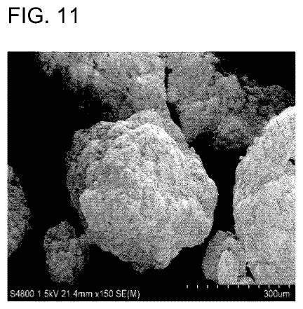

The resulting wet powder was placed on a stainless steel mesh tray and the mesh tray was heated in a hot-air-circulating electric furnace at 130° C. After 20 hours, the mesh tray was taken and air-cooled, whereby a PTFE/PVDF powder mixture was obtained. The resulting PTFE/PVDF powder mixture had a mixing ratio (mass ratio) of PTFE/PVDF=50/50. A micrograph of the resulting powder is shown in FIG. 11.

The resulting PTFE/PVDF powder mixture was used as Binder 1.

### Production Example 2

A container was charged with 298 g of the PTFE-1 powder obtained in Preparation Example 2, 255 g of the PVDF aqueous dispersion obtained in Preparation Example 4, and 1000 g of deionized water. The mixture was co-coagulated under stirring as in Production Example 1 and then dried, whereby a powder mixture was obtained. The resulting PTFE/PVDF powder mixture had a mixing ratio (mass ratio) of PTFE/PVDF=85/15.

The resulting PTFE/PVDF powder mixture was used as Binder 2.

### Production Example 3

A container was charged with 1176 g of the PTFE-1 aqueous dispersion obtained in Preparation Example 1, 53 g of the PVDF powder obtained in Preparation Example 5, and 1113 g of deionized water. The mixture was co-coagulated under rapid stirring as in Production Example 1 and then dried, whereby a powder mixture was obtained. The resulting PTFE/PVDF powder mixture had a mixing ratio (mass ratio) of PTFE/PVDF=85/15. The resulting PTFE/PVDF powder mixture was used as Binder 3.

### Production Example 4

A container was charged with 1176 g of the PTFE-1 aqueous dispersion obtained in Preparation Example 1, 53 g of the VdF/TFE copolymer (fluoropolymer A) powder obtained in Preparation Example 6, and 1113 g of deionized water. The mixture was co-coagulated under rapid stirring as in Production Example 1 and then dried, whereby a powder mixture was obtained. The resulting PTFE/fluoropolymer A powder mixture had a mixing ratio (mass ratio) of PTFE/fluoropolymer A=85/15. The resulting PTFE/fluoropolymer A powder mixture was used as Binder 4.

### Production Example 5

A container was charged with 1176 g of the PTFE-1 aqueous dispersion obtained in Preparation Example 1, 53 g of the Et/TFE/HFP copolymer (EFEP) powder obtained in Preparation Example 7, and 1113 g of deionized water. The mixture was co-coagulated under rapid stirring as in Production Example 1 and then dried, whereby a powder mixture was obtained. The resulting PTFE/EFEP powder mixture had a mixing ratio (mass ratio) of PTFE/EFEP=85/15. The resulting PTFE/EFEP powder mixture was used as Binder 5.

### Production Example 6

A container was charged with 1002 g of the PTFE-2 aqueous dispersion obtained in Preparation Example 3, 255 g of the PVDF aqueous dispersion obtained in Preparation Example 4, and 1032 g of deionized water. The mixture was co-coagulated under rapid stirring as in Production Example 1 and then dried, whereby a powder mixture was obtained. The resulting PTFE/PVDF powder mixture had a mixing ratio (mass ratio) of PTFE/PVDF=85/15. The resulting PTFE/PVDF powder mixture was used as Binder 6.

### Production Example 7

A container was charged with 1245 g of the PTFE-1 aqueous dispersion obtained in Preparation Example 1, 173 g of the VDF/TFP elastomer (elastomer A) aqueous dispersion obtained in Preparation Example 8, and 1005 g of deionized water. The mixture was co-coagulated under rapid stirring as in Production Example 1 and then dried, whereby a powder mixture was obtained. The resulting PTFE/elastomer A powder mixture had a mixing ratio (mass ratio) of PTFE/elastomer A=90/10. The resulting PTFE/elastomer A powder mixture was used as Binder 7.

### Production Example 8

A container was charged with 1107 g of the PTFE-1 aqueous dispersion obtained in Preparation Example 1 and 260 g of the VDF/HFP elastomer (elastomer B) aqueous dispersion obtained in Preparation Example 9. The mixture was co-coagulated under rapid stirring as in Production Example 1 and then dried, whereby a powder mixture was obtained. The resulting PTFE/elastomer B powder mixture had a mixing ratio (mass ratio) of PTFE/elastomer B=80/20. The resulting PTFE/elastomer B powder mixture was used as Binder 8.

### Production Example 9

A high-speed mixer was charged with 85 g of the PTFE-1 powder obtained in Preparation Example 2 and 15 g of the PVDF powder obtained in Preparation Example 5, and the components were mixed at 20000 rpm for two minutes. The resulting PTFE/PVDF powder mixture had a mixing ratio (mass ratio) of PTFE/PVDF=85/15. The average particle size exceeded 2000 μm and was therefore unmeasurable.

The resulting PTFE/PVDF powder mixture was used as Binder 9.

The results of the binders obtained in Preparation Examples 1 to 9 are shown in Table 1.

TABLE 1

| | | Average | Maximum | Aspect ratio | |
|---|---|---|---|---|---|
| | Water | particle size | particle size | 30 or | 10 or |
| | content | of powder | (D90) | higher | higher |
| | Mass ppm | μ | μ | % | % |
| Binder 1 | <10 | 580 | 960 | 0 | 0 |
| Binder 2 | <10 | 480 | 980 | 0 | 6 |
| Binder 3 | <10 | 420 | 900 | 0 | 0 |
| Binder 4 | <10 | 440 | 880 | 0 | 0 |
| Binder 5 | <10 | 460 | 920 | 0 | 0 |
| Binder 6 | <10 | 490 | 960 | 0 | 0 |
| Binder 7 | 26 | 670 | 1060 | 0 | 0 |
| Binder 8 | 42 | 680 | 1080 | 0 | 0 |
| Binder 9 | <10 | >2000 | — | 25 | 53 |

### Examples 1 to 7 and Comparative Example 1

Using each of the powders obtained above, a positive electrode mixture sheet, an electrode, and a lithium ion secondary battery were produced and evaluated by the following methods.

One of the binder powders, an electrode active material NMC811 (LiNi_{0.8}Co_{0.1}Mn_{0.1}O₂), and a conductive additive (Super P Li available from Imerys S. A.) were weighed for the composition (mass ratio) shown in Table 2 or 4. In order to reduce fibrillation, mixing of the materials was performed at 19° C. or lower. The weighed materials were cooled to −25° C., fed to a blender, and stirred at 8000 rpm for one minute in total. The mixture was fed into a pressure kneader that had been pre-warmed to 30° C. and kneaded at 50 rpm for five minutes, whereby an electrode mixture powder was obtained. The resulting electrode mixture powder was rolled through parallel metal rollers, whereby the electrode mixture powder was processed into a bulky product. The bulky electrode mixture was rolled through the rollers in the same manner multiple times, whereby a self-standing electrode mixture sheet was produced. The temperature of the metal rollers was set to 100° C. The thickness of the electrode mixture sheet was adjusted to about 100 μm. Test pieces were cut out of this electrode mixture sheet and used for evaluation of the variation of tensile strength.

This electrode mixture sheet was also cut to have a width of 40 mm and placed on aluminum foil having a coarsened surface and a size similar to that of the electrode mixture sheet. The workpiece was rolled using a roller press (distance between rollers: 100 μm, pressure: 15 kN) that had been heated to 100° C., whereby an electrode was produced.

### Examples 8 and 10 and Comparative Example 2

One of the binder powders, a positive electrode active material NMC811 (LiNi_{0.8}Co_{0.1}Mn_{0.1}O₂), a sulfide-based solid electrolyte LPS (0.75Li₂S.0.25P₂S₅), and a conductive additive (Super P Li available from Imerys S. A.) were combined for the composition (mass ratio) shown in Table 3 or 4. The subsequent procedure was the same as in Example 1.

### Examples 9 and 11 and Comparative Example 3

One of the binder powders, a negative electrode active material graphite, a sulfide-based solid electrolyte LPS (0.75Li₂S.0.25P₂S₅), and a conductive additive (Super P Li available from Imerys S. A.) were combined for the composition (mass ratio) shown in Table 3 or 4. The subsequent procedure was the same as in Example 1.

### (Evaluation of Variation of Tensile Strength)

A tensile tester (AGS-100NX, Autograph AGS-X series, available from Shimadzu Corp.) was used to determine the variation of tensile strength of 4-mm-width strip-shaped test pieces of the electrode mixture sheet at 100 ram/min. The chuck distance was set to 30 mm. A displacement was applied to each test piece until breaking, and the maximum stress of the measured results was taken as the strength of the test piece. An average was calculated for each experiment, with the average maximum stress of Comparative Example 1, Comparative Example 2, or Comparative Example 3 taken as 100. The standard variation was determined and the coefficient of variation CV (standard deviation/average×100) was calculated, which was taken as the value for evaluating the variation. Thereby, the variation of tensile strength was evaluated. The results are shown in Tables 2 to 4.

### (Peeling Strength Between Electrode Mixture and Current Collector)

The electrode was cut to form test pieces having a size of 1.0 cm×5.0 cm. The electrode material side of a test piece was fixed to a mobile jig with double-sided tape and a different tape was attached to a surface of the current collector. The latter tape was pulled at an angle of 90 degrees at a rate of 100 ram/min, and the stress (N/cm) was measured using an autograph. The values within a stable range of the stress were averaged, whereby the peeling strength was determined. The test was performed at n=5 and the average was taken as the evaluation value. The autograph was provided with a 1 N load cell.

In comparison with the corresponding comparative example, the examples were evaluated as follows:
Excellent: 126% or higher
Good: 106 to 125%
Poor: 105 to 95%, equivalent to the comparative example.

TABLE 2

| | | | | | Results after processing | |
|---|---|---|---|---|---|---|
| | | | | | | Peel strength |
| | Composition of electrode | | | | Variation of | of electrode |
| | Active | Conductive | | Composition | electrode strength | (relative to |
| | material | additive | Binder | ratio | (CV) | Comparative Example 1) |
| Example 1 | NMC811 | Super P Li | Binder 1 | 96.7:1.6:1.7 | 5.5 | Good |
| Example 2 | NMC811 | Super P Li | Binder 2 | 96.7:1.6:1.7 | 6.5 | Good |
| Example 3 | NMC811 | Super P Li | Binder 3 | 96.7:1.6:1.7 | 6.2 | Good |
| Example 4 | NMC811 | Super P Li | Binder 4 | 96.7:1.6:1.7 | 4.7 | Excellent |
| Example 5 | NMC811 | Super P Li | Binder 5 | 96.7:1.6:1.7 | 6.8 | Good |
| Example 6 | NMC811 | Super P Li | Binder 6 | 96.7:1.6:1.7 | 4.6 | Excellent |
| Example 7 | NMC811 | Super P Li | Binder 7 | 96.7:1.6:1.7 | 3.9 | Excellent |

TABLE 3

| | | | | | | Results after processing | |
|---|---|---|---|---|---|---|---|
| | Composition of electrode | | | | | Variation of | |
| | Active | Conductive | Solid | | Composition | electrode strength | Peel strength |
| | material | additive | electrolyte | Binder | ratio | (CV) | of electrode |
| Example 8 | NMC811 | Super P Li | LPS | Binder 7 | 70:1:28.4:0.6 | 3.5 | Excellent (relative to |
| | | | | | | | Comparative Example 2) |
| Example 9 | Graphite | Super P Li | LPS | Binder 7 | 70:1:28.4:0.6 | 4.4 | Excellent (relative to |
| | | | | | | | Comparative Example 3) |
| Example 10 | NMC811 | Super P Li | LPS | Binder 8 | 70:1:28.4:0.6 | 3.5 | Excellent (relative to |
| | | | | | | | Comparative Example 2) |
| Example 11 | Graphite | Super P Li | LPS | Binder 8 | 70:1:28.4:0.6 | 3.8 | Excellent (relative to |
| | | | | | | | Comparative Example 3) |

TABLE 4

| | | | | | | Results after processing | |
|---|---|---|---|---|---|---|---|
| | Composition of electrode | | | | | Variation of | |
| | Active | Conductive | Solid | | Composition | electrode strength | Peel strength |
| | material | additive | electrolyte | Binder | ratio | (CV) | of electrode |
| Comparative | NMC811 | Super P Li | — | Binder 9 | 96.7:1.6:1.7 | 7.5 | — |
| Example 1 | | | | | | | |
| Comparative | NMC811 | Super P Li | LPS | Binder 9 | 70:1:28.4:0.6 | 7.1 | — |
| Example 2 | | | | | | | |
| Comparative | Graphite | Super P Li | LPS | Binder 9 | 70:1:28.4:0.6 | 6.9 | — |
| Example 3 | | | | | | | |

1.-102. (canceled)

103. A composite binder material, the material comprising:
(a) polytetrafluoroethylene (PTFE);
(b) a low-melting point thermoplastic; and
(c) a conductive additive.

104. The composite binder material as claimed in claim 103, wherein the composite binder material is a particulate.

105. The composite binder material as claimed in claim 103, wherein the composite binder material is a coagulum.

106. The composite binder material as claimed in claim 103, wherein the conductive additive is present in an amount of from about 0.01% to about 20% w/w.

107. The composite binder material as claimed in claim 103, wherein the low-melting point thermoplastic is present in an amount of from about 0.01% w/w to about 50% w/w and has a melting point below 375° C.

108. The composite binder material as claimed in claim 103, wherein the PTFE is present in an amount of from about 25% w/w to about 99% w/w.

109. The composite binder material as claimed in claim 103, wherein the PTFE is a homopolymer or comprises a perfluorinated copolymer.

110. The composite binder material as claimed in claim 103, wherein the PTFE is a modified PTFE comprising TFE and a modifying monomer copolymerizable with the TFE.

111. The composite binder material as claimed in claim 103, wherein the PTFE is a high molecular weight PTFE having a standard specific gravity of 2.20 or less.

112. The composite binder material as claimed in claim 103,
wherein the low-melting point thermoplastic is a low-melting point fluoropolymer, and
wherein the low-melting point fluoropolymer is PVdF, FEP, EFEP, ETFE, THV, FKM, FFKM, PFA, PVF, or a combination of two or more of the foregoing.

113. The composite binder material as claimed in claim 103, wherein the low-melting point thermoplastic is a low-melting point non-fluorinated polymer selected from the group consisting of a polyolefin, PE, PP, PA, Nylon, PS, TPU, PI, PA, PC, PLA, PEEK, PEG/PEO, or a combination of two or more of the foregoing.

114. The composite binder material as claimed in claim 103, wherein the low-melting point thermoplastic is a powder having an average particle size of about 700 μm or less.

115. The composite binder material as claimed in claim 103, wherein the low-melting point thermoplastic is an emulsion having an average primary particle size of about 500 nm or less.

116. The composite binder material as claimed in claim 103, wherein the conductive additive is selected from the group of consisting of carbon nanoparticle, carbon nanotube, carbon black, acetylene black, or a combination of two or more of the foregoing.

117. The composite binder material as claimed in claim 103, wherein the composite binder material has an adhesion strength of >1 Nmm with high-purity aluminum, when adhesion tested using a 25 mm width film with high-purity aluminum on both sides.

118. A method of making the composite binder material as claimed in claim 103, the method comprising:
(a) providing an emulsion of PTFE;
(b) mixing a low-melting point thermoplastic and a particulate conductive additive into the emulsion of PTFE to form a first mixture; and
(c) coagulating the first mixture to produce a coagulum comprising the composite binder material.

119. The method as claimed in claim 118, further comprising drying the coagulum at below about 375° C.

120. The method as claimed in claim 118, wherein the coagulating is performed at a temperature at or below about 90° C.

121. A binder powder for an electrochemical device, comprising:
a non-fibrillated fibrillatable resin; and
a thermoplastic polymer.

122. An electrode mixture obtained using the binder powder for an electrochemical device as claimed in claim 121.

123. An electrode for a secondary battery, the electrode being obtained using the binder powder for an electrochemical device as claimed in claim 121.

124. A secondary battery comprising the electrode for a secondary battery as claimed in claim 123.

125. A method for producing a binder powder for an electrochemical device, the method comprising:
a step (1) of preparing a mixture containing a fibrillatable resin, a thermoplastic polymer, and water; and
a step (2) of producing a powder from the mixture.

126. A binder for an electrochemical device, the binder comprising:
a fibrillatable resin; and
an ethylene/tetrafluoroethylene copolymer.

127. A binder for an electrochemical device, the binder comprising:
a fibrillatable resin; and
an elastomer having a glass transition temperature of 25° C. or lower.

128. An electrode mixture obtained using the binder for an electrochemical device as claimed in claim 126.

129. An electrode for a secondary battery, the electrode being obtained using the binder for an electrochemical device as claimed in claim 126.

130. A secondary battery comprising the electrode for a secondary battery as claimed in claim 129.
